(19) United States
(12) Patent Application Publication
(10) Pub. No.: US 2005/0064019 A1
(43) Pub. Date: Mar. 24, 2005

(54) Impregnated, flexible, rawhide pet chews containing antimicrobially active chlorhexdine

(76) Inventors: Ira D. Hill, Austin, TX (US); Dale G. Brown, Wharton, TX (US)

Correspondence Address: BANNER & WITCOFF, LTD., 28 STATE STREET, 28th FLOOR, BOSTON, MA, 02109-9601, US

(21) Appl. No.: 10/989,188

(22) Filed: Nov. 15, 2004

Related U.S. Application Data
(63) Continuation-in-part of application No. 10/361,311, filed on Feb. 10, 2003.

(51) Int. Cl. A23K 1/165; A23K 1/17

(52) U.S. Cl. 424/442; 426/635

(57) ABSTRACT

Therapeutic, flexible, tough, rawhide pet chews impregnated with an emulsion and/or surfactant containing antimicrobially active chlorhexidine suitable for releasing said antimicrobially active chlorhexidine over the chew-life of the chew to: help control, disrupt and remove biofilms, treat fetid breath and treat gum disease in pets.

### CROSS-REFERENCE TO RELATED APPLICATION

This application is a continuation-in-part of copending application Ser. No. 10/361,311, filed 10 Feb. 2003, the disclosure of which is hereby incorporated herein by reference. The parent application was published as Patent Application Publication No. US 2004/0156884 on Aug. 12, 2004.

### FIELD OF THE INVENTION

The present invention is directed to novel therapeutic, impregnated, flexible, rawhide pet chews suitable for: (a) controlling, disrupting and removing biofilms in pets, (b) controlling the fetid breath associated with pet biofilms, and/or (c) delivering antimicrobially active chlorhexidine to pet's teeth and gums to treat biofilms, gum disease and fetid breath in pets. These therapeutic, flexible, impregnated, rawhide chews are regularly introduced into the pet's oral cavity to release emulsions and/or surfactants containing substantive, antimicrobially active chlorhexidine. A critical feature of this invention is that antimicrobially active chlorhexidine is consistently released into the pet's oral cavity over the “chew-life” of the flexible rawhide chew. These flexible, impregnated, rawhide chews indicate a flexibility (Elasticity Modulus) of at least about 0.1 Gigapascal (Gpa) and a Shore-D Hardness of at least about 35.

### BACKGROUND OF THE INVENTION

Unlike humans, pets do not chew and thoroughly masticate their food before swallowing. Because most of their teeth are sectorial in design (i.e., built for tearing and shredding meat from a carcass and not grinding), pets do not have serious problems with caries. That is, due to limited masticating, pets generally do not pack food and debris between their teeth like humans do. However, pets are domesticated carnivores, taken out of the wild. Accordingly, they no longer have the opportunity to regularly rip, tear and/or shred meat from the carcass of their prey. This lack of “carnivore-type” activity renders most domesticated pets vulnerable to gum disease.

Unfortunately, like their civilized owners, domesticated pets generally suffer from gum disease at about the same incidence as adult humans. For example, more than 86% of the dogs and cats older than four years of age that are brought to veterinary clinics have periodontal disease. See Colmery B., Front R., Vet. Clin. N. America, 18:891 (1982).

Periodontal disease is the overwhelming reason for tooth loss in dogs. Unfortunately, in most cases, treatment for periodontal disease must continue for the life of the pet, because of the pet's continued susceptibility and the chronicity of the disease. Groe T. K., The Compendium on Continuing Education, Vol. 564, No. 7, June 1982.

Periodontal disease in the domestic cat was studied by Rerchart P. A., et al., and reported in J. Periodont. Res., 19:67 (1984). Periodontal disease is the most common dental disease in cats. J.V.D., Vol. 5, No. 2, June 1988, and is the most prevalent disease condition found in cats today, Cats Magazine, 16-18, January 1987.

Periodontal problems are progressive. The first occurrence is the formation of plaque (more accurately described as biofilm), which is a transparent, adhesive fluid composed of the mucin in saliva, food particles, sloughed epithelial cells from the abrasive process of eating and the mouth's resident bacteria (usually aerobic Gram-positive, nonmotile cocci). The adhesive matrix that contains the bacteria is called the pellicle.

Soft plaque can be removed from teeth by the mechanical action of brushing. If plaque is not removed, the mineral salts in the saliva, particularly calcium carbonate, will precipitate into the plaque forming hard dental calculus (tartar). Eventually, this hard, rough-surfaced tartar is irritating to the tissue wall of the gingival sulcus. This irritation inflames the soft tissues.

Specifically, tartar can be defined as an incrustation of the teeth consisting of salivary secretion, food residue and various salts, such as calcium carbonate or phosphate.

When tartar or plaque (biofilm) collects on the teeth, it creates pressure on the gums causing them to become inflamed and to recede. Affected gums appear reddish-blue in color and bleed easily. Teeth in neglected pets may become loose. At this state, pus can be expressed from the surface of the gums when mild pressure is applied. Stoder E. and Stapley R. D., Veterinary Medicine/Small Animal Clinician, 1124, October 1973.

The organisms present in inflamed tissue are usually anaerobic, Gram-negative, motile bacilli. See: Eisner E. R., Veterinary Medicine, 97-104, January 1989, Frost R., Williams C. A., Vet. Clin. N. Amer., 16(5) 851-874 (1986); Harvey E. E., et al., Textbook of Veterinary Internal Medicine, W. B. Saunders, Philadelphia, Pa. (1982), pp. 1126-1187. Harvey C. E., Veterinary Dentistry, W. B. Saunders, Phila Pa. (1985), pp. 34-66, 956-199. Ross D. L., Current Veterinary Therapy, VI, W. B. Saunders, Phila Pa. (1977), pp. 918-921; Eisenmenger, E. Zetner C., Veterinary Dentistry, Lea & Febiger, Phila, Pa. (1985) pp. 131-150; Harvey C. E., Textbook of Small Animal Surgery, W. B. Saunders, Philadelphia, Pa. (1985), pp. 615-620. The depth of the gingival sulcus in dogs suffering from gum disease extends from a normal condition of 1-2 mm in depth to an abnormal condition of 3-4 mm in depth, or greater. The detachment of the gingiva and the formation of periodontal pockets begins at this depth of the gingival sulcus.

Of the several signs of periodontal disease readily evident to the examining veterinarian as well as the owner, the most common presenting sign is “halitosis”, i.e., “fetid breath”. Kyle M. A., J.V.D. Vol. 5, No. 2, June 1988. This bad breath is a byproduct of the infection in the mouth. Pain due to the bacterial toxins produced accompanies this condition. If the oral pain is severe enough, irritability and improper eating habits generally develop. Eisner E. R., Veterinary Medicine, 97-104, January 1989.

Biofilm formation in pets is an extremely complex process. Immediately after removal of bacteria from the tooth surface by prophylaxis, a ubiquitous layer of dental pellicle is formed on tooth surfaces. The early bacterial colonizers, mostly facultative gram-positive Streptococci and Actinomyces species, adhere to the dental pellicles on the tooth surface. Following the adherence of early colonizers, the biofilm increases its cell numbers mainly by bacterial growth.

The microbial composition of biofilms gradually becomes more diversified, and after two to three weeks, the biofilm becomes a mature bacterial community. During biofilm development, various types of bacterial adhesives mediate the attachment of the bacteria to receptors in dental pellicles or on the surface of other bacteria. See Davey and O'Toole, “Microbial biofilms: from ecology to molecular genetics” Microbiol. Mol. Biol. Rey. 64: 847-67 (2000).

Periodontitis can be prevented by keeping the pet's teeth clear of plaque and tartar buildup (biofilm), by regular cleansing of the teeth and gums or by periodic mechanical removal of tartar and/or plaque by an oral care professional. Studer E., Stapley R. D., Veterinary Medicine/Small Animal Clinician, 1124, October 1983.

According to Eisner E. R., “Basic home care consisting of regular brushing to maintain healthy teeth and gums is the cornerstone of treatment for periodontal disease in pets.” Veterinary Medicine, 698-708, July 1989.

Unfortunately, dental hygiene in pets is something that most owners neglect. Many pet owners are unaware that just like people, pets require regular dental care. Most pet treat manufacturers have attempted at one time or another to incorporate various oral hygiene benefits in their pet care products. To date, these oral care adjuncts to pet food, chews, treats, etc., have not proven too successful, as the previously referenced survey of oral hygiene of pets older than four years of age brought to veterinary clinics indicates. Various rawhide chew toys have been the primary focus for attempting to remove and/or control biofilms in pets.

Rawhide is a byproduct of the slaughter of hoofed animals and consists of the hide, tendons, etc. of the animal. Rawhide contains about 65-70% water, 30-35% dry material and less than 1% ash. The dry material is largely made up of fibrous proteins, collagen, keratin, elastin and reticulin. Due to this high water content, previously known methods of processing rawhide required that the rawhide be dried before it is used to produce pet chews. For a detailed description of rawhide, see:

Chemical Technology: An Encyclopedic Treatment, Vol. V, Barnes & Noble Books, (1972), pages 392 to 406, is a general disclosure of types of leathers and their uses, and the tanning of leather. Arnold, John R., Hides and Skins, (1925), pages 6, 7, 252, 253, 310 and 311, is a general disclosure on raw and tanned hides and skins.

Footwear And Leather Abstracts, Information Retrieval Limited, Vol. II, No. 1, (1967), page 61, discloses several methods for the depilation of skins and raw hides and for processing raw hide.

North American Packer Hides, Pratt Bros. Co., (1939), page 107, defines rawhide leather as being hides that have been limed, dehaired and stuffed with oil or grease, but otherwise not tanned. Flemming, Louis, A., Practical Tanning, (1910), pages 81 to 83, describes methods of making lace leather.

Churchill, James E., “The Complete Book of Tanning Skins And Furs”, (1983), page 165, discloses how to make rawhide. Page 166 discloses that rawhide and objects made from rawhide will be eaten by dogs and other animals unless they are treated with mineral oil or another preservative.

Partridge, John, “Chemical Treatment of Hides And Leather”, (1972), pages 2 to 43, deals with the chemical preservation of raw hides and skins and the chemical dehairing of skins and hides. The treatments include: removing hair using a solution of lime containing an inorganic phospho-sulfur compound containing at least one P—S bond; and dehairing using enzymatic action with K₂HPO₄ as a pH adjuster.

Thorstensen, Thomas C., Practical Leather Technology, (1985), pages 1 to 41, deals with the preparation of hides.

Kirk-Othmer, Encyclopedia of Chemical Technology, 3^{rd} Ed., Vol. 14, (1981), pages 200 to 216, is a general article on leather. Pages 213, 215 and 216 disclose that polyphosphates are excellent pretannages for vegetable tanning. Optimum molecular weights of the polyphosphates are from 1500 to 2500. Also there is a minimum-effluent vegetable tanning system, known as the Liritan process. The limed and bated hides are treated for 24 hours in a pit with 5 percent of sodium hexametaphosphate (Calgon) solution and sufficient sulfuric acid to achieve a pH of 2.8 at the end of that time. This part of the process has become known as the Calgon pickle. The solution is reused daily, being regenerated with additional sodium hexametaphosphate and sulfuric acid, and is discarded only once a year. The treatment presumably prepares the hides for a more rapid vegetable tanning process, and the recommended one with varied concentration of wattle (mimosa) takes 11 days. The tanning liquors are recirculated and reused. Further finishing of leathers that have been prepared by the Liritan combination tannage process, as a non-effluent rapid tannage for sole leather, is used by sole-leather tanneries throughout the world.

Early methods of manufacturing pet chews out of substantially pure rawhide were as simple as preparing and drying rawhide strips until they were hard and bonelike. These nonmechanical methods consist of preparing the rawhide by removing, either chemically or otherwise, the fat and hair found in the cattle ligaments and other material which comprise the raw starting material. The treated rawhide is then split, cut and rolled into the desired shape, such as a rope or strip, and dried. Coloring, flavor additives and antitartar ingredients are applied to surfaces of the chew by coating or basting the outside of the rawhide strip once dry.

One of the simpler methods requires drying the cut rawhide in the sun, before the rolling step, in order to preserve the rawhide. Prior to the rolling process, the dried rawhide is dipped in water, making it soft and easier to roll. The rawhide therefore needs very little drying once rolled. However, this drying process results in yellow or brown bones which are generally unappealing to pet owners.

Another nonmechanical method consists of working with the rawhide in the wet state, possibly wringing the rawhide out before processing. Under this process, the rawhide is cut and rolled in the wet state.

The nonmechanical “clean, cut and dry” methods of producing pet chews are labor and energy intensive and time consuming. The methods are labor intensive because the treated skins are sorted depending on their size, laid out, cut into big strips, distributed to the workers who roll them into bones, placed on trays, shipped to the ovens and usually turned over once a day until dry. There are also problems with quality control. Because of all the manual work involved, the percentage of “seconds” and rejects is unreasonably high, compared to machine made products. These methods are energy intensive because the rawhide has to be dried slowly once rolled to obtain a hard (15% moisture content) product. Slow drying is necessary because of the risk of cooking the rolled product into gelatin. Typically the drying process can last up to 15-20 days, starting off with a very low temperature (approximately 50° C.) and gradually reaching 80° C. The drying can involve electric fans and wood heated air, running 24 hours a day.

In one preferred method of making rawhide products in accordance with the present invention, cowhides are split and thoroughly washed and cleaned of bacteria. The hide is treated and processed in the same manner as for conventional rawhide chew toys, with materials such as detergents, water and anti-hair materials. The washed hides are then sanitized, such as by being tumbled in liquid hydrogen peroxide and then thoroughly rinsed with water. Excess water is then removed, such as by pressing the hides between the nip of two pinch rollers. At this point, the hides are relatively soft and flexible, but may contain as much as 75% absorbed water. These hides are then ready for impregnation processes of this invention.

Illustrative of a nonmechanical method for manufacturing rawhide chews is U.S. Pat. No. 5,149,550 to Mohilef (1992), which teaches the manufacture of pet chews by (1) washing ligaments from cattle and other hoofstock in an aqueous degreasing solution or roasting, thereby rendering the ligaments substantially free of fat, and (ii) drying until hard.

U.S. Pat. No. 5,047,231 to Spanier, et al., (1991) discloses a process for preparing rawhide by adding an inorganic pyrophosphate compound to rawhide strips and then drying the rawhide. The resultant pyrophosphate coated product, when chewed by the dog, reportedly results in reduced tartar accumulation on the dog's teeth.

In an effort to address the problem of choking and intestinal blockage associated with bulk rawhide, pet chew products have been developed utilizing rawhide that has been chopped, sliced, shredded, ground, pulverized or otherwise comminuted. The comminuted pieces are then wetted, optionally fortified with adhesives, resins, etc., and finally compacted or compression molded. Although the removal of a significant portion of the water during the molding process enhances the resulting product's integrity, the compression molding process nonetheless has its limits with regard to the ultimate strength characteristics of the final product. Limiting the moldings to relatively small sizes also serves to yield a stronger product, although peeling or delaminating is still a problem. While the disassociated particles tend to be of a physically small size and are therefore able to pass harmlessly through the dog's intestinal tract, ingestion thereof can nonetheless cause problems.

An additional approach has been employed in the past wherein comminuted rawhide, in combination with a variety of additives, is first compression molded and then baked. While the baking step has a sterilizing effect and thereby addresses the decay problem described above, the end product tends to be extremely hard and dense, and is therefore not particularly “chewable.” Moreover, due to its brittleness, it is quickly and easily shattered by a large dog, and consequently is quickly consumed.

In the course of subjecting the rawhide to melting temperatures during the injection molding process, the material becomes sterilized. This serves to interrupt any decaying process that may be in progress, and thereby alleviates the foul odor normally associated with rawhide chew toys. Furthermore, sterilization is achieved without baking the molded material so as to yield a very chewable product with a consistency and texture preferred by most dogs. By injection molding a molten medium, a substantially more cohesive product is formed than is possible using compression or compaction molding techniques.

### PRIOR ART

The prior art teaches there is a need: (a) to make frequent cleanings of the teeth of dogs more convenient, and (b) to make cleaning of pet teeth easier for the pet owner to carry out. To date, this need is substantially unmet.

A number of pet chew products have been developed over a long period of time in an attempt to address this long-felt need. For example, U.S. Pat. No. 3,882,257 to Cagle describes a pet food product in which a slurry is dehydrated and made into a simulated bone for dogs which can help exercise the jaws and gums and help to remove tartar from the teeth. U.S. Pat. No. 4,145,447 to Fisheret al., discloses an animal food which is chew resistant and can help remove plaque or tartar from animal teeth. Still another product of this type is disclosed in U.S. Pat. No. 5,094,870 to Scaglione, et al., which discloses a process for preparing dog biscuits containing at least one inorganic phosphate salt. The dog biscuits are (hopefully) chewed and/or eaten by the dog with the result that tartar accumulations on its teeth are reduced or prevented. U.S. Pat. Nos. 5,296,209 and 5,407,661, both to Simone, et al., describe a pet chew product having a flexible cellular matrix in which is contained a cellulose fibrous material such as corn cob fractions having a mechanical cleansing function, which, when chewed by the pet, is intended to effect a reduction in plaque, stain and tartar on the pet's teeth. While the foregoing approaches may be meritorious, they involve creating a unique food product (as distinguished from a “chew toy”), which is a relatively complex and expensive undertaking with no guarantee that the resultant product will be accepted and actively consumed by dogs.

U.S. Pat. No. 5,100,651 to Boyer discloses a health product for the care of teeth of dogs, capable of being chewed or gnawed by the dogs, which contains fluoride, antimicrobial agents, and anti-decay agents.

U.S. Pat. No. 5,296,217 to Stookey discloses a method for preventing dental calculus using sequestering agents applied to commercially prepared diets of domestic animals. The sequestering agents form soluble calculus complexes in saliva and dental plaque, thereby preventing the calcifying dental plaques. Sodium hexametaphosphate has been utilized as a preferred sequestering agent. These sequestering agents can be added to dog treats, i.e., biscuits, and/or to the surface of chew toys such as rawhide.

U.S. Pat. No. 5,310,541 to Montgomery describes an animal chew product containing one or more enzymes and substrates for the purpose of generating antimicrobial compounds upon contact with animal saliva, for tartar prevention.

U.S. Pat. No. 5,431,927 to Hand et al., describes a pet food prepared from a fiber containing nutritionally balanced mixture of carbohydrates, protein, fat, vitamins and minerals. The product has an expanded striated structure matrix which fractures when chewed by a pet, creating a mechanical tooth cleansing function which acts to reduce plaque, stains and tartar on the pet's teeth.

U.S. Pat. No. 5,467,741 to O'Rourke discloses a chew toy for dogs which is molded from soft pliable threads twisted about one or more strands of twisted synthetic fibers. The twisted fibers are impregnated with one ore more breath freshening or flavoring agents so as to dispense the agent as the dog chews.

U.S. Pat. No. 5,618,518 to Stookey discloses a chew product containing sodium hexametaphosphate, which is useful against the buildup of dental calculus.

U.S. Pat. No. 5,904,614 to Cyr et al., discloses a food dog bone made of 93% casein, poultry meal, and gelatin, and 7% of an anti-tartar composition used in the control of tartar in domestic animals such as dogs.

U.S. Pat. No. 5,908,614 to Montgomery describes a peroxidase-activating oral care composition including an enzymatic water soluble hydrogen peroxide precursor and pH adjusting agent. The composition facilitates the rapid release of hydrogen peroxide and results in the activation of a peroxidase enzyme in an oral cavity.

U.S. Pat. No. 5,944,516 to Deshaies discloses a device for cleaning the teeth of a dog, consisting of brushes, onto which toothpaste is automatically dispensed during a brushing procedure.

U.S. Pat. No. 5,989,604 to Wolf et al., discloses a pet foodstuff and treatment method for reducing the incidence of dental caries in non-human animals. Xylitol containing foodstuff is used.

Early pet food jerky that was made by dehydrating low fat beef muscle tissue was highly palatable and could provide a reasonable “chew-life” if sliced and dried in thick strips. Attempts have been made to toughen reformed jerky products to improve the “chew-life”. Neilberger (U.S. Pat. No. 5,026,572) disclosed a multiple extrusion method of producing jerky by extruding a blend of wet beef and flour and then incorporating the cooked product of this first extrusion into a second extrusion step. Ray (U.S. Pat. No. 5,290,584) teaches the utilization of frozen mechanically separated meats that are comminuted to a small particle size and then mixed with pregelatinized flour prior to elevated temperature extrusion. Scaglione (U.S. Pat. No. 4,868,002) describes a process for making a tougher jerky using fibrous components of animal tissue or plant tissue such as wheat straw, alginates or industrial generated fibers.

Many long-lasting synthetic chews have been developed in attempts to address the “chew-life” issue. Axelrod (U.S. Pat. No. 4,771,733) discloses a method whereby an aqueous based flavor or odor is incorporated into a polyurethane resin based dog chew to improve the palatability of the product. Axelrod attempted further improvements to this technology (U.S. Pat. No. 5,339,771) by dispersing an animal meal within the matrix of a synthetic thermoplastic molded bone. Axelrod also discloses (U.S. Pat. No. 5,240,720) an injection molded chew produced from rennet casein and gelatin which can be heated by the consumer in a microwave oven to cause the chew to expand and thereby render it more easily chewable.

Other literature references of interest include:
Kornman, Journal of Periodontol. Res., Supplement 5:22 (1986)
Chen, Journal of the California Dental Assoc., 2001.
Kolenbrander P. E., Methods Enzymol, 253:385-97, 1995.
Kolenbrander, P. E., J. Applied Bacteriol., 78:795-865, 1993.
Grander S., J. Antimicrob. Chemother., 37:1047-50, 1996.
Davies D. G., Parsek M. R., Science, 280:295-8, 1998.
Papapanou P. N., Annu. Periodontol., 1:1-36, 1996.
Socransky S. S., Haffajee A. D., Periodontol. 2000, 5:7-25, 1994.
Moore W. E. C., Moore L. V. H., Periodontol. 2000, 5:66-77, 1994.
Socransky S. S. Haffajee A. D., J. Periodontol., 63:322-31, 1992.
Zambon J. J., Annu. Periodontol., 1:879-932, 1996.
Whittaker C. J., Klier C. M., Kolenbrander P. E., Annu. Rev. Microbiol., 50:513-52, 1996.
Wilson M., Patel H., Fletcher J., Oral Microbiol. Immunol., 11:188-192, 1996.

It is known in the art to apply a coating on rawhide chews by using a baste. Conventional baste may be used to provide desired coloring and/or flavoring or odor to make the chew toy more appealing to pets and their owners. Particular baste formulations can provide a more natural-looking color that pet owners are more inclined to purchase. For example, U.S. Pat. No. 5,673,653, issued to Sherrill on Oct. 7, 1997 (Sherrill), col. 1, lines 55-65, discloses various types of bastes applied to rawhide chew toys. Basting has also been used in commercial attempts to apply active ingredients to surfaces of rawhide chew toys; for example, enzymes, antimicrobials and tartar control salts.

U.S. Pat. No. 6,223,693 teaches a soft rawhide pet chew containing a polyol humectant and a binder, whereby the moisture content of the rawhide is increased while maintaining an acceptable low water activity. The “softness” taught and claimed is: “ . . . comparable to that of suede or leather.” The presence of the humectant and binder not only contributes to the softness of the rawhide product, but permits an increase in the moisture content and/or flexibility of the rawhide while still maintaining an acceptably low water activity.

The concept of tough, flexible, rawhide chews is neither taught nor implied by U.S. Pat. No. 6,223,693. Neither does the '693 patent teach nor suggest using emulsions and/or surfactants as impregnating substances to impart limited flexibility in combination with a toughness attribute with exceptional penetration properties. The concept of using impregnating substances other than polyol humectants is neither suggested nor implied.

Other patent references of interest include:
U.S. Pat. Nos. 6,350,438; 5,114,704; 5,011,679; 4,260,635; 4,702,929; 5,609,913; 5,673,653; 5,827,565; 4,674,444; 5,100,651; 4,546,001; 4,364,925; 5,200,212; 6,365,133; 5,476,069; 5,635,237; 5,215,038; 5,329,881 and 5,467,741.

The effect of chewing rawhide “chips” (Chew-eez®, Superior Brands, Inc.) was compared with a leading cereal biscuit (Milk Bone®, Nabisco Brands, Inc.) on the removal of calculus in dogs reported in Jayma, Vol. 197, No. 2, Jul. 15, 1990, to with: “ . . . rawhide removed calculus considerably better than cereal biscuits for the study period.” In U.S. Pat. Nos. 5,009,973 and 5,015,485 assigned to Nabisco Brands, Inc., cereal biscuits (similar to Milk Bone®) containing pyrophosphate were reported to prevent tartar accumulation on the teeth of dogs. However, the chewing and eating of 12 such biscuits a day was required by a small dog to achieve the effect reported. This comprises 25 to 33% of the small dog's daily caloric requirement.

The act of regularly chewing an object (such as rawhide) sufficiently rigid to allow for an oral residence time of greater than thirty seconds or so has been shown to result in reduced tartar accumulation compared to a quickly consumable object, such as a biscuit (Lags, et al., J. Am. Veterinary Medical Association., 197, pp. 2 13-219 (1990).

Particularly relevant additional U.S. patents include:
U.S. Pat. Nos. 6,074,662; 6,277,420; 6,238,715; 6,350,438; 6,165,474; 5,047,231; 6,365,133; 6,159,508; 6,309,676; 5,635,237; 5,114,704; 5,011,679; and 6,365,133.

Chew toys for dogs perform several important functions. First, and most importantly, these toys facilitate several health functions, such as teeth and gum cleaning, gum massage and chewing exercise. Benefits of these functions include the prevention of periodontal disease and tartar buildup, as well as the promotion of healthy teeth and jaw development. Dogs often do not have access to natural bones and hard objects that scour their teeth when chewed and assist in healthy dental development, and owners must sometimes look to toys or snacks in order to fill this void. A variety of artificial chew toys have been created in an attempt to achieve these health benefits, with varying degrees of success. For instance, artificial chew toys have been made from rawhide, woven fibers, and ropes. However, these materials are often rapidly destroyed by the chewing action which breaks down the fibers and structure of the material, and the soft nature of these products cannot provide the same degree and variety of health benefits that can be obtained from chew toys that are comprised of harder material.

As noted above, pet chews for dogs perform several important functions. First, and most importantly, these chews facilitate several health functions, such as teeth and gum cleaning, gum massage and chewing exercise. Benefits of these functions include the prevention of periodontal disease and tartar buildup, as well as the promotion of healthy teeth and jaw development. Dogs often do not have access to natural bones and hard objects that scour their teeth when chewed and assist in healthy dental development, and owners must sometimes look to chews or snacks in order to fill this void.

A variety of artificial chews have been created in an attempt to achieve these health benefits, with varying degrees of success. For instance, artificial chews have been made from rawhide, woven fibers, and ropes. However, these materials are often rapidly destroyed by the chewing action which breaks down the fibers and structure of the material, and the soft nature of these products cannot provide the same degree and variety of health benefits that can be obtained from chews that are comprised of harder material.

Another important function of chews is to divert destructive chewing behavior and to provide amusement and entertainment for the animal. Chews can provide an outlet for the animal to expend its chewing energies which might otherwise by directed in a destructive manner on household objects. The degree of acceptability of the chew by the animal will determine the effectiveness and success of the product in this regard. Additionally, the chew should have an appeal to the animal and offer a means of entertainment and amusement to keep the dog happy over time, preferably over long periods of time. Therefore, it should be appreciated that there exists a need for an improved chew that will generate a longer period of sustained interest by dogs, thereby imparting needed health and entertainment for the animal.

Rawhide pet chews are a preferred means for cleaning tooth surfaces and physically fighting biofilm formation in pets. Depending on their shape and size, rawhide pet chews are generally chewed for extended periods, while effectively controlling, removing, disrupting and/or weakening biofilms through the normal physical/cleaning actions associated with the rawhide mastication process, referred to hereinafter as “physical/cleaning-type action”.

Such chew products typically have a useful life (referred to hereinafter as “chew-life”) of several minutes to several hours. This “chew-life”, in addition to providing long-term cleaning-type action, provides an ideal means for continually transferring biofilm disrupting ingredients and/or antimicrobially active chlorhexidine to the pet's oral cavity. Unfortunately traditional antimicrobially active chlorhexidine basted rawhide pet chews do not release antimicrobially active chlorhexidine consistently, over the chew-life of the chew. This consistent release of antimicrobially active chlorhexidine throughout the chew-life of the pet chew is a key attribute of the therapeutic, rawhide pet chews of the present invention.

### The Antimicrobial Chlorhexidine

To date, therapeutic rawhide pet chews, where a therapeutic agent such as chlorhexidine is added to the surface of the rawhide, have had, at best, marginal success in contributing to rawhide's consistent physical/cleaning/controlling, removing and/or disruption of biofilms from the teeth of pets suffering from gum disease. And, such surface treatments of rawhide chews, invariably result in staining of rugs, carpeting, upholstery, etc., which has become a major “turn-off” to pet owners.

Chlorhexidine digluconate at 0.12% has been marketed in the U.S. since about 1986 as an Rx rinse for treating gingivitis in humans under the brand, Peridex®. Clinically-based antigingivitis efficacy of Peridex® is attributed primarily to chlorhexidine's substantivity. Once introduced into the oral cavity, antimicrobial activity from 6 to 12 hours is reported for chlorhexidine. Other chlorhexidine salts are also suitable for purposes of the present invention. These include chlorhexidine: diacetate, dilactate, etc.

Various species of bacteria are thought to be involved in the pathogenesis of periodontal disease. Chlorhexidine is a broad spectrum antimicrobial agent. The mechanism by which chlorhexidine exerts antimicrobial effects is not well defined, but may include damage to the bacterial cell wall through action similar to that of a surfactant.

The antimicrobial spectrum of activity of chlorhexidine includes vegetative gram-positive and gram-negative bacteria inclusive of vegetative anaerobes. Chlorhexidine is inactive against bacterial spores except at elevated temperatures. Chlorhexidine has antifungal activity with this activity being greater against the yeast forms than the mold forms. The level of activity varies with the species of the fungi. As is the case with bacterial spores chlorhexidine is inactive against fungal spores. Chlorhexidine has been shown to have clinically relevant activity against those bacteria which have been associated with periodontal disease.

Studies in 1964 demonstrated that chlorhexidine was an effective agent for disinfecting the oral mucosa covering a periodontal infection, Birch, et al. (1964) “A comparison of root canal and apical lesion flora,” Brit. Journal Dent., 116: 350-352; and for disinfection of root canals, Atkinson and Hampson (1964) “Sterilization of root canals,” Brit. Journal Dent., 117: 526-528.

The first clinical studies on the plaque inhibitory effects of chlorhexidine (Hibitane®) were reported by Renggii (1968) Med. Diss. Zurich; Mühlemann (1973) Odontolonica Acta, 17: 99-103; Loë and Schiött (1970) “Dental Plaque” Ed. McHugh, W. D., 1970, Edinburgh; Gjerno, Baastad and Rölla (1970) P. Journal Period. Res., 5: 102-109; Flötra, Gjermo, et al. (1972) Scand. Journal Dent. Res., 80: 10-17; Loë, Schiött, et al. (1976) Journal Period. Res., 11: 35-144. Cationic chlorhexidine salts possess a strong affinity to hydroxyapatite and to acidic proteins on the tooth surface, according to Rölla, Loë and Schiött (1970) Journal Period. Res., 5: 90-95.

The calculus (tartar)-inhibiting capacity of chlorhexidine has been studied by Schroeder (1969) “Formation and Inhibition of Plaque”, pp. 145-162, Berne, Stuttgart, Vienna, Hans Huber Publisher.

In 1970, Loë and Schiött, reported results of the first group of an extensive list of investigations which clearly documented that chlorhexidine was the most effective anti-plaque and anti-gingivitis agent which had been evaluated up to that time. Loë and Schiött (1970) J. Period. Res., 5: 79-83.

The toxicity for chlorhexidine is low. Rats have been shown to tolerate 0.05 and 0.2% aqueous solutions of chlorhexidine as the only source of drinking water for more than six months without detectable interference with growth and reproduction: Davies, et al. (1954) Brit. J. Pharmacology, 9: 192-196.

Since 1954, chlorhexidine salts have been used clinically for disinfection of operation sites, in the treatment of burns and in urology and gynecology: Beeuwkes and DeVries (1956) Lancet II, pp. 913-914; Grant & Findley (1957) Lancet II, pp. 862-863; Lowbury, et al. (1964) Brit. Medical Journal II, pp. 531-536; Gillespie, et al. (1964) Brit. Medical Journal II, pp. 423-425.

The effect of chlorhexidine in disinfection of the oral mucosa has been reported by Cawson and Curson, 1959, Brit. Dental Journal, 107: 69-70.

Of prime importance to chlorhexidine safety were the long term trials demonstrating the safety of the antiseptic with no systemic or serious local side effects observed after two years continuous use. Nuki, et al. (1976) J. Periodont. Res., 11(3): 172-175; Schiött, et al. (1976) J. Periodont. Res., 11(3): 153-157.

The use of chlorhexidine in periodontal treatment is also described in the following references:
Soskolne, et al., J. Periodontol., 68(1): 32-38 (1987 January)
Vandekerckhove, et al., J. Periodontol., 67(12): 1251-1259 (1996 December)
Christie, et al., J. Chin. Periodontol., 25(1): 15-23 (1988)
Walsh, et al., J. Chin. Periodontol., 19(4): 245-248 (1992)
Bollen & Quirynen, J. Periodontol., 67(11): 1143-1158 (1996)
Bollen, et al., J. Clinical Periodontol., 23(10): 960-970 (1996)
Addy, et al., J. Oral Rehabil., 23(4): 219-231 (1996)
Shiloah & Patters, J. Periodontol., 67(2): 130-139 (1996)
Valente, et al., J. Can. Dent. Assoc., 62(1): 46-48 (1996)
Smith, et al., J. Chin. Periodontol., 23(1): 19-23 (1996)
Quirynan, et al., J. Dent. Res., 74(8): 1459-1467 (1995)
Ozean, et al., J. Nihon Univ. Sch. Dent., 36(3): 191-198 (1994)
Shiloah & Patters, J. Periodontol., 65(6): 458-578 (1994)
Baker, Curr. Opin. Periodontol., 89-98 (1993)
Chapple, et al., J. Periodontol., 63(10): 812-816 (1992)
Reynolds, et al., J. Chin. Periodontol., 19(8): 595-600 (1992)
Foirellini & Paquette, Curr. Opin. Dent., 2: 63-79 (1992)
Berswanger, et al., J. Chin. Dent., 3(2): 33-38 (1992)
Stabholz, et al., Chin. Rev. Dent., 13(5): 9-14 (1991)
Meurman, et al., J. Chin. Periodontol., 18(8): 587-591 (1991)
Stabholz, et al., J. Periodontol., 62(7): 429-433 (1991)
Needleman, Br. Dent. J., 170(11): 405-408 (1991)
Osterneal, et al., J. Chin. Periodontol., 18(4): 245-251 (1991)
Osterneal, et al., J. Chin. Periodontol., 18(2): 97-100 (1991)
Jolkovsky, et al., J. Periodontol., 61(11): 663-669 (1990)
Cervone, et al., Endod. Dent. Travmatol, 6(1): 33-36 (1990)
Taggart, et al., J. Chin. Periodontol., 17(1): 32-37 (1990)
Newman, et al., J. Periodontol., 60(10): 577-581 (1989)
Sanz, et al., J. Periodontol., 60(10): 570-576 (1989)
Southard, et al., J. Periodontol., 60(6): 302-309 (1989)
Wennstrom, et al., J. Chin. Periodontol., 14(10): 573-580 (1987)
Wennstrom, et al., J. Chin. Periodontol., 14(9): 541-550 (1987)
Bollen. et al., J. Chin. Periodontol., 25(1): 56-66 (1998).

The following additional references cover: (a) chlorhexidine, (b) chlorhexidine treatments for pets. and (c) pet products for fighting plaque, tartar and/or gingivitis:

Addy, “Chlorhexidine compared with other locally delivered antimicrobials. A short review.” J. Clin. Periodontol. 13: 957-964, (1986).

“This brief review of antimicrobials in supragingival plaque control indicates that to date, chlorhexidine is the most effective and safe antiplaque agent available. The published information for efficacy suggests chlorhexidine cold theoretically be substituted for the toothbrush in supragingival plaque control.”

Rawlings, et al., “Effect on Canine Oral Health of Adding Chlorhexidine to a Dental Hygiene Chew.” J. Vet. Dent., 15(3): 129-134 (1998).

“Incorporation of chemical antiplaque agents in oral hygiene products is a way of augmenting mechanical cleaning procedures in controlling supragingival plaque formation, thus helping to prevent the onset of early periodontal disease.”

Gorrel and Rawlings, “The Role of a Dental Hygiene Chew in Maintaining Periodontal Health in Dogs.” J. Vet. Dent., 13(1): 31-34 (1996).

“The study demonstrated that the dally addition of the chew to the dry diet was effective in reducing plaque and calculus accumulation on the tooth surfaces.” Gorrel, et al., “Effect of a New Dental Hygiene Chew on Periodontal Health in Dogs.” J. Vet. Dent., 16(2): 77-81 (1999).

“Daily addition of the chew to the dry diet was effective in reducing plaque and calculus accumulation on the tooth surfaces, and also reduced the severity of gingivitis and oral malodor as compared to feeding the dry diet only.”

Hennet, “Effectiveness of an Enzymatic Rawhide Dental Chew to Reduce Plaque in Beagle Dogs,” J. Dent. Vet., 18(2): 61-64 (2001).

“The rawhide dental chew provided in the study reported here decreases plaque formation in the prevention of progressive periodontal disease associated with attachment loss if provided on a long-term basis.”

Hennet, “Effectiveness of a Dental Gel to Reduce Plaque in Beagle Dogs.” J. Vet. Dent., 19(1): 11-14(2002).

“The dental gel (containing chlorhexidine) applied in the study reported here decreases plaque accumulation in the short term and may be beneficial in reducing the severity of gingivitis associated periodontal disease if provided on a long-term basis.” (The gel used was Virbac's DentiVet.)
Goldstein, et al., “The effect of rawhide strips in the removal and prevention of plaque and calculus.” Proc. Vet. Dent. Forum, p. 29 (1993).
Goldstein, et al., “Beefhide strips in the maintenance of dental health.” Pro. Vet. Dent. Forum., p. 81 (1994).
Duke, “How a chewing device affects calculus buildup in dogs,” Vet. Med., 84: 1110-1114 (1999).
Eley, British Dental Journal Vol. 186(6): 286-295, Mar. 27, 1999.
Smith, et al., “The efficacy of an anti-gingivitis chewing gum,” J. Clin. Periodontol., 23: 19-23 (1996).
Tellefsen, et al., “Use of chlorhexidine chewing gum significantly reduces dental plaque formation compared to similar xylitol and sorbitol products,” J. Periodontol., 67: 181-183 (1996).
Bonesvoll, et al., Arch. Oral Biol., 19 (1974) 209.
R. Schrott and Loe, J. Periodontol. Res., 7 (1972) 192.
Jones, Periodontol. 2000, 1997. 1:55-62.
Gorrel and Bierer, J. Vet. Dent., 1999. 16:109-133.

As noted above, the substantivity of chlorhexidine may pose a problem, when adding chlorhexidine to rawhide chews. That is, the chlorhexidine, when added to rawhide from an aqueous soak, may attach to rawhide protein and may no longer be available as an antimicrobial, anti-biofilm agent when the chlorhexidine containing rawhide is chewed. As detailed below, soaking fresh rawhide in chlorhexidine aqueous solutions results in the chlorhexidine penetrating the rawhide; however, the chlorhexidine substantivity moiety could attach the chlorhexidine to the rawhide such that microbially active chlorhexidine is no longer available to the pet's oral cavity when the chlorhexidine treated rawhide is subsequently chewed. This “tie-up” of chlorhexidine by the rawhide is observed for fresh and dried rawhide, where each is treated with chlorhexidine.

### OBJECTS OF THE INVENTION

An object of the present invention is to provide therapeutic, flexible, tough, impregnated, rawhide chews, containing substantive, antimicrobially active chlorhexidine, suitable for controlling, disrupting and removing biofilms in pets, and for treating gum disease and fetid breath.

A further object of the invention is to provide flexible, tough, rawhide pet chews impregnated substantially throughout with antimicrobially active chlorhexidine that is releasable as an active antimicrobial over the chew-life of the chew for the purpose of helping to control, disrupt and remove biofilms in pets; to treat gum disease and fetid breath.

Another object of the invention is to provide means and a process for impregnating rawhide pet chews substantially throughout with antimicrobially active chlorhexidine that can be released in an antimicrobially active state into the oral cavity of pets during chewing to help control, disrupt and remove biofilms, treat gum disease and fetid breath.

Another object of the invention is to provide a means and a process for imparting flexibility and toughness into rawhide, while impregnating said rawhide with emulsions and/or surfactants containing antimicrobially active chlorhexidine.

Still another object of the invention is to provide a treatment for controlling, disrupting and removing biofilms and for treating gum disease and/or fetid breath in pets, comprising: periodically providing the pet with treated, flexible, tough, rawhide chews impregnated substantially throughout with emulsions and/or surfactants containing antimicrobially active chlorhexidine, plus one or more antiplaque, antitartar ingredients and/or other oral care ingredients, that are released over the chew-life of the pet chew onto the surfaces of the pet's teeth and gums.

Another object of the invention is to enhance the palatability of therapeutic, flexible, tough, impregnated, rawhide pet chews.

Another object of the invention is to provide means for physically disrupting rawhide and for impregnating disrupted rawhide substantially throughout with biofilm disrupting emulsions and/or surfactants containing antimicrobially active chlorhexidine, plus ore or more antiplaque antitartar ingredients or other therapeutic, oral care ingredients, which are subsequently released into the oral cavity of pets over the chew-life of the chew.

Still another object of the invention is to provide a treatment for biofilms, fetid breath and gum disease in pets, comprising periodically providing the pet with treated, flexible, tough, rawhide chews impregnated substantially throughout with biofilm disrupting, controlling and removing emulsions and/or surfactants containing antimicrobially active chlorhexidine, plus one or more antiplaque, antitartar antimicrobial ingredients and/or other therapeutic, oral care ingredients, which can be released over the chew-life of the chew.

Yet another object of the invention is to improve rawhide pet chews by impregnating said chews substantially throughout with antimicrobially active chlorhexidine contained in an emulsion and/or surfactant, where said emulsion and/or surfactant also contains other ingredients that are also releasable, along with the antimicrobially active chlorhexidine, over the chew-life of the chew.

A further object of the invention is to provide a wide range of flexible: tough, fresh, dried and comminuted rawhide pet chews, impregnated substantially throughout with emulsions and/or surfactants containing antimicrobially active chlorhexidine.

Still another object of the invention is to provide means and a process to disrupt rawhide sufficiently to affect impregnation throughout the rawhide with emulsions and/or surfactants containing antimicrobially active chlorhexidine and whereby the impregnated rawhide indicates flexibility and toughness throughout its chew-life.

### SUMMARY OF THE INVENTION

The present invention is directed to therapeutic, flexible, tough, rawhide pet chews impregnated substantially throughout with an emulsion and/or surfactant containing antimicrobially active chlorhexidine. Surprisingly, the chlorhexidine impregnated substantially throughout the flexible, rawhide pet chew in various emulsions and/or surfactants is available in an antimicrobially active state and is capable of releasing throughout the chew-life of the pet chew to help chemotherapeutically control, disrupt and remove biofilms that form on the teeth of pets. These therapeutic, impregnated, rawhide pet chews exhibit a wide range of flexibility and toughness, with a flexibility value (Elasticity Modulus) of at least about 0.1 Gpa, and are surprisingly tough as indicated by their Shore-D Hardness values of at least about 35. This flexibility value is attributed to impregnating the rawhide with various surfactants and/or emulsions. The method of manufacturing these impregnated, flexible, tough, therapeutic, rawhide pet chews and methods of using these therapeutic pet chews to treat biofilms, gum disease and fetid breath, are also included in the present invention. These impregnated, flexible, tough, therapeutic, rawhide chews with their flexibility of at least about 0.1 Gpa, with toughness as indicated by their Shore-D Hardness of at least about 35, and extended chew-life, are neither taught nor suggested by the prior art referenced above.

A preferred embodiment of the present invention is directed to flexible, tough, therapeutic, rawhide pet chews where the rawhide is physically disrupted and impregnated substantially throughout with emulsions and/or surfactants containing antimicrobially active chlorhexidine. Unexpectedly, this active chlorhexidine is releasable over the chew-life of the flexible rawhide chew at a level sufficient to help treat biofilms, fetid breath and gum disease in pets.

The emulsions and/or surfactants containing antimicrobially active chlorhexidine are impregnated substantially throughout the physically disrupted and impregnated rawhide chew, irrespective of size, shape, or whether the rawhide to be impregnated is fresh or has already been dried or comminuted. These various impregnated, therapeutic, rawhide pet chews indicate various degrees of flexibility and toughness, depending upon the extent of physical disruption and the level of surfactant and/or emulsion impregnation throughout the chew, and surprisingly remain consistently tough with an excellent chew-life.

The surfactant and/or emulsion containing, antimicrobially active chlorhexidine in the flexible chews of the present invention can be distinguished from traditional basted and/or coated rawhide pet chews described in the prior art. For example:
The antimicrobially active chlorhexidine containing emulsion and/or surfactant is impregnated substantially throughout the disrupted, flexible, tough, rawhide pet chews of the present invention.
The antimicrobially active chlorhexidine released from the impregnated, flexible, tough, rawhide pet chew of the present invention remains antimicrobially active over the chew-life of the chew.
The emulsions and/or surfactants containing antimicrobially active chlorhexidine impregnated throughout the flexible, tough, rawhide pet chew, are releasable over the chew-life of the flexible, rawhide chew at levels substantially greater than those available from basting and/or other surface coating processes. This consistent availability of antimicrobially active chlorhexidine results in superior therapeutic attributes over the chew-life of the impregnated rawhide chew, including effectively treating biofilms, gum disease and fetid breath.
Distinctive, unexpected, flexibility and toughness is achieved with the impregnated, rawhide pet chews of the present invention, wherein said chews retain a flexibility value of at least about 0.1 Gpa throughout its chew-life, and wherein the impregnated rawhide chews demonstrate exceptional toughness with a Shore-D Hardness of at least about 35. This results in an extended chew-life with superior cleaning, control, disruption and removal of biofilms attributed, in part, to the intrinsic toughness associated with this distinctive, chlorhexidine impregnated, flexible rawhide.
Enhanced pet preference is characteristic of the impregnated, therapeutic, flexible, tough, pet chews of the present invention which is attributed, in part, to the flavor, mouth feel additives, conditioners, etc., distributed substantially throughout the flexible rawhide chew along with the emulsions and/or surfactants containing antimicrobially active chlorhexidine. This pet preference is observable over the chew-life of the impregnated, flexible product and is indicated by the intensity with which the pet chews these therapeutic chews, as well as by the frequency of chewing by the pet.
Flexibility and toughness, with a flexibility value of at least about 0.1 Gpa and a Shore-D Hardness of at least about 35, are attributed to the combination of physical disruption of the rawhide, as illustrated in FIGS. 1a and 1b of the Drawings, along with impregnating the pet chews with impregnating substances of the invention, as illustrated in FIGS. 1c and 11. These impregnating substances include surfactants and/or emulsions which can also contain antimicrobially active chlorhexidine, which are distributed and retained throughout the flexible, tough, impregnated, rawhide chew as antimicrobially active chlorhexidine over the chew-life of the product.
Enhanced pet owner acceptance attributed to the therapeutic, flexible, tough, rawhide chew also being impregnated substantially throughout with antimicrobially active chlorhexidine, and/or including flavorants, conditioners, mouthfeel agents, etc., that encourage the pet to chew with greater intensity, for longer periods and with greater frequency.

Particularly preferred: (a) emulsions for impregnating substantially throughout the flexible, tough, rawhide pet chews of the present invention include MICRODENT® and ULTRAMULSION®, and (b) surfactants for impregnating substantially throughout the rawhide pet chews of the present invention, include essentially all ingestible surfactants, as described in detail below.

The biofilm disrupting/controlling properties of MICRODENT® emulsions in humans, have been extensively documented using chewing gums and mints as a MICRODENT® emulsion delivery vehicle. For example, reductions in plaque greater than 35% have been reported in clinical studies on chewing gums containing up to about 2% by weight MICRODENT® emulsion. Other clinical studies on MICRODENT® emulsion containing mints showed plaque reductions of about 20% with up to about 2% by weight MICRODENT® emulsion. It has been suggested that MICRODENT® emulsion impregnated, flexible rawhide pet chews of the present invention would, like chewing gum, continuously release the anti-biofilm MICRODENT® emulsion into the pet's oral cavity while the pet is chewing the impregnated, therapeutic, rawhide chew.

Masticating the flexible, tough, therapeutic, rawhide pet chews of the present invention provides an excellent physical cleaning action for pet teeth, which is particularly effective in controlling newly formed biofilm, particularly when this physical cleaning is combined with the release of a surfactant and/or a MICRODENT® and/or ULTRAMULSION® emulsion which simultaneously coats the entire oral cavity with this substantive, surface-energy altering emulsion and/or surfactant containing antimicrobially active chlorhexidine.

In addition to their biofilm disrupting properties, the preferred MICRODENT® and ULTRAMULSION® emulsions and/or the ingestible surfactants are particularly effective as carriers for a antimicrobially active chlorhexidine as well as various flavorants, conditioners, mouthfeel agents, etc., the latter of which tend to encourage aggressive chewing and maintain pet interest in the therapeutic, impregnated, flexible, rawhide pet chews of the invention throughout their chew-life.

### BRIEF DESCRIPTION OF THE DRAWINGS

FIGS. 1a through 1c are schematic presentations of rawhide cross-sections.

FIG. 1a is a schematic cross-sectional view of a piece of intact, fresh rawhide, prior to physical disruption and impregnation showing microscopic passageways. Dried rawhide is schematically similar to fresh rawhide except that the collagen-like areas are substantially free of water, and thus proportionally thinner.

FIG. 1b is a schematic cross-sectional view of a piece of fresh rawhide shown in FIG. 1a, after it has been physically disrupted as illustrated with its microscopic passageways enlarged.

FIG. 1c is a schematic cross-sectional view of a piece of rawhide that has been physically disrupted as shown in FIG. 1b and subsequently, the microscopic passageways are impregnated with an impregnating emulsion and/or surfactant containing antimicrobially active chlorhexidine. The capillary spaces have been penetrated by the impregnating substance which commingled itself with the water-soluble or water-dispersible proteins, preventing them from hardening and binding to fibrous components usually associated with dried rawhide.

FIGS. 2 through 10a illustrate several physical disrupting and impregnating means for rawhide, where:

FIG. 2 is a three-dimensional perspective view illustrating a rotating barrel, tumbling rawhide disrupting/impregnating means.

FIG. 3 is a side perspective view of the rotating barrel rawhide tumbling/disrupting/impregnating means shown in FIG. 2.

FIG. 4 is a front perspective view of the rotating barrel rawhide tumbling/disrupting/impregnating means shown in FIG. 3.

FIG. 5 is an inside cross-sectional view of the rotating barrel rawhide tumbling/disrupting/impregnating means shown in FIG. 2 fitted with a series of rawhide disrupting, permanently fixed, fin means secured to the wall of said barrel means in a pattern that maximizes rawhide disruption when said barrel is rotating and the rawhide present in the barrel is tumbling.

FIG. 6 is a side view of the inside of the rotating barrel rawhide tumbling/disrupting/impregnating means showing secured, rawhide disrupting fins extending the length of said rotating barrel means.

FIG. 6a is a detailed cross-sectional view of a single rawhide disrupting fin means.

FIG. 7 is an inside cross-sectional view of the rotating barrel, rawhide tumbling/disrupting/impregnating fin means shown in FIG. 2 fitted with an alternative series of rawhide disrupting, permanent fixed fin means secured to the wall of said barrel means in a pattern that maximizes rawhide disruption when said barrel is rotating.

FIG. 8 is a side view of the inside rotating barrel rawhide tumbling/disrupting/impregnating means depicted in FIG. 7 showing an alternative secured, rawhide disrupting fins extending the length of said rotating barrel means.

FIG. 8a is a detailed cross-sectional view of a single rawhide disrupting fin means, shown in FIG. 8.

FIG. 9 is an inside cross-sectional view of the rotating barrel, rawhide tumbling/disrupting/impregnating means shown in FIG. 2 fitted with an alternative series of rawhide disrupting/impregnating, permanently fixed, fin means secured to the wall of said barrel means in a pattern that maximizes rawhide disruption when said barrel is rotating and the rawhide present inside the barrel is tumbling.

FIG. 10 is a side view of the inside rotating, barrel rawhide tumbling/disrupting/impregnating means depicted in FIG. 9 showing an alternative secured, rawhide disrupting fins extending the length of said rotating barrel means.

FIG. 10a is a detailed cross-sectional view of a single rawhide disrupting fin means shown in FIG. 10.

FIG. 11 is a microphotograph of cross-sections of two pieces of rawhide that have been soaked and disrupted/impregnated, respectively, with an emulsion of the invention, wherein said emulsion contains a blue dye.

FIG. 12 is a side view of a Tensile Testing Machine suitable for establishing flexibility values in Gigapascals (Gpa).

### DEFINITIONS OF KEY TERMS

For the purposes of the present invention, the following key terms are defined as set out below:

“Rawhide” is defined as the byproduct of the slaughter of hoofed animals and consists of the hide, tendons, etc., and includes fresh rawhide, dried rawhide, compressed rawhide, comminuted rawhide and mixtures thereof. The dry material is largely made up of fibrous proteins, collagen, keratin, elastin and reticulin. Rawhide products originate from the natural skins of animals. In addition to cows, animal skins, such as pig, goat and water buffalo skins can also be used. To form rawhide, a cow or other animal hide is split. The top grain is generally tanned and formed into leather products. The bottom half of the hide is generally kept in its natural “raw” state. Hides in such natural, untanned state, are generally referred to as rawhide. One common use for rawhide is the production of chemicals such as gelatin. Another important use for rawhide is the manufacture of edible chew toys for pets, such as dogs.

“Rawhide pet chews” are defined as consumable pet chews, which are free from bacteria, as well as dangerous substances such as formaldehyde and other preservatives which can be used to prevent the rawhide from becoming contaminated by bacteria, microbes, maggots and the like. A rawhide chew is also free from processing chemicals commonly used in the tanning of leather which make the leather soft. Not only are these unhealthy for a dog, but training a dog to chew on a chew which smells like leather could fool a dog into thinking that it is acceptable to chew on a shoe or leather handbag. In order to make rawhide chews acceptably resistant to bacterial contamination, rawhide chews are commonly sold in a substantially dehydrated state. An acceptably low moisture content can lead to a safe or stable water activity. Thus, if the water activity of the rawhide article is too high, there is a possibility that the chew will be contaminated by mold, bacteria and the like, or otherwise become unsanitary and potentially harmful for the pet. Thus, rawhide pet chew products contain less than about 13% moisture in order to have an acceptable water activity below about 0.75.

Rawhide also includes other animal parts such as ears and snouts. That is, dried ear and ear pieces consist primarily of a section of hard-firm ear cartilage with a piece of skin (rawhide) on each side. The resultant dog chew, comprised of an ear which includes two pieces of rawhide and hard cartilage sandwiched there between provides prolonged chewing time over similarly available chews manufactured solely of rawhide, resulting in consequently increased abrasive effect on the teeth surfaces. More particularly, there is provided a pet chew product comprising an inner layer of cartilage sandwiched between opposing outer layers of animal skin. The inner layer of cartilage preferably comprises a dried animal ear portion, and the outer layers of animal skin preferably comprise rawhide.

“Therapeutic rawhide pet chews” are defined as impregnated pet chews that contain ingestible antimicrobially active chlorhexidine, plus other ingredients can also be present that help treat tartar, biofilm buildup, fetid breath and gum disease in pets.

“Marinated rawhide” is defined as a fresh or dried rawhide soaked in a simple solution of flavorings and colorants to impart a pleasant effect to the rawhide. Simple salts, like tartar control pyrophosphates or sodium fluoride, can also be marinated into dried rawhide without the benefit of an impregnating agent.

“Basted rawhide” is defined as the common commercial method of introducing flavorings, enzymes, anti-tartar agents, anti-biofilm agents and other oral care providing materials to the surface of dried rawhide. Most commonly this is accomplished by coating the surface of the rawhide by spraying, with or without tumbling, with a solution or suspension of the desired basting material so that it is uniformly distributed across the surfaces of the rawhide pieces. The slightly wetted surface is then dried briefly in a warm air source.

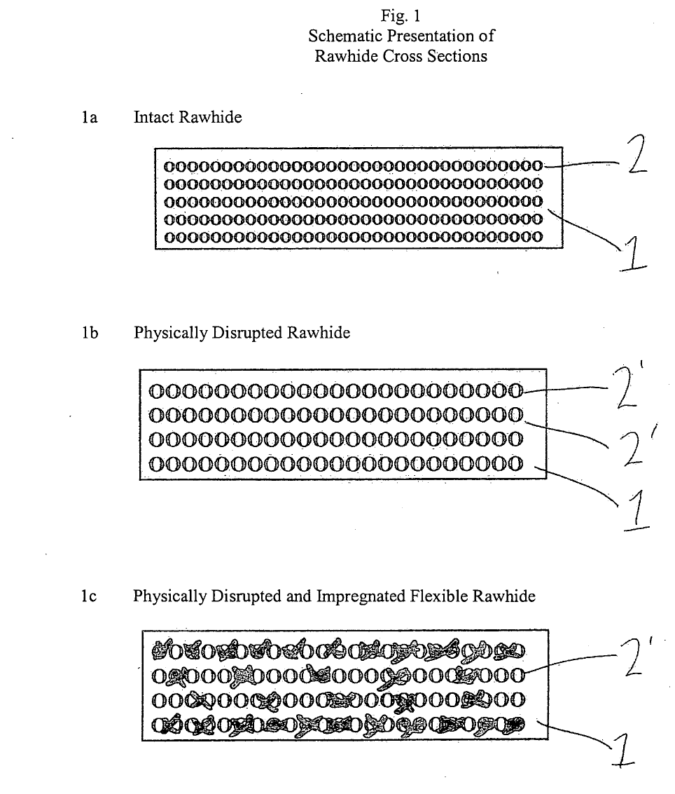

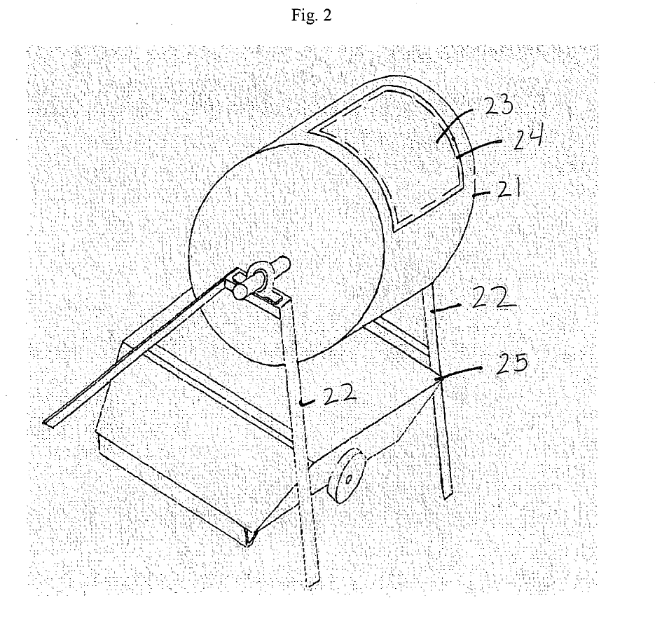

“Impregnated rawhide” is defined as flexible, tough, disrupted rawhide that has been penetrated substantially throughout with emulsions and/or surfactants, as schematically illustrated in FIG. 1c. One preferred embodiment is tumbling with a controlled quantity of liquid emulsion and/or surfactant, as described in FIGS. 2 through 10 of the drawings, containing antimicrobially active chlorhexidine. Another preferred embodiment, these emulsions and/or surfactants can be introduced into the rawhide by means of soaking the rawhide in a water bath containing said emulsions and/or surfactants.

“Water activity” is defined by Encyclopedia of Food Science, AVI Publishing as the ratio of the vapor pressure exerted by the water contained in the product to the vapor pressure of pure water at the same temperature. The lower the water activity of a product, the less susceptible that product is to the growth of bacterial, fungal and yeast organisms. Fruits, bread and meat all have water activities above 0.95. In contrast, crackers, cereal and sugar can have a water activity as low as 0.1.

“Periodontal disease” (“gum disease”) is a broad term used to describe those diseases which attack the gingiva and the underlying alveolar bone supporting the pet's teeth. The disease exists in a number of species of warm blooded animals such as canines and felines, and includes a series of diseases exhibiting various syndromes which vary from each other according to the stage or situation of the disease or the age of the pet. The term is used for any inflammatory disease which initially occurs at a marginal gingiva area and may affect the alveolar bone. Periodontal disease affects the periodontium, which is the investing and supporting tissue surrounding a tooth (i.e., the periodontal ligament, the gingiva, and the alveolar bone). Two common periodontal diseases are gingivitis (inflammation of the gingiva) and periodontitis (inflammation of the periodontal ligament manifested by progressive resorption of alveolar bone, increasing mobility of the teeth, and loss of the teeth at advanced stage). Other terms used for various aspects of periodontal disease are “acute necrotizing ulcerative gingivitis” and “alveolar pyorrhea”. Periodontal disease may involve one or more of the following conditions: inflammation of the gingiva, formation of periodontal pockets, bleeding and/or pus discharge from the periodontal pockets, resorption of alveolar bone, loose teeth and loss of teeth. Periodontal disease is generally considered to be caused by/associated with bacteria which are generally present in dental plaque which forms on the surface of the teeth and in the periodontal pocket. Thus, known methods for treating periodontal disease often include the use of antimicrobials and/or anti-inflammatory drugs.

“Biofilm (plaque),” the precursor of dental calculus/tartar, is defined as a community of bacteria embedded in exopolysaccharide that adheres to tooth surfaces and are a major source of the infections associated with gum disease in pets. The early bacterial colonizers of biofilm, which are mostly faculative gram-positive Streptococci and Actinomyces species, adhere to the dental pellicles on the tooth surface. Following the adherence of early colonizers, the biofilm increases its cell numbers mainly by bacterial growth. Antimicrobially active chlorhexidine is particularly effective in controlling biofilms.

“Dental calculus,” or tartar as it is sometimes called, is defined as a calcified deposit of hardened plaque (biofilm) which forms on the surfaces of the teeth at the gingival margin. Supragingival calculus appears principally in the areas near the orifices of the salivary ducts; e.g., on the lingual surfaces of the lower anterior teeth and on the buccal surfaces of the upper first and second molars, and on the distal surfaces of the posterior molars. Mature calculus consists of an inorganic portion which is largely calcium phosphate arranged in a hydroxylapatite crystal lattice structure similar to bone. enamel and dentin. An organic portion (biofilm) is also present and consists of desquamated epithelial cells, leukocytes, salivary sediment, food debris and various types of microorganisms.

As the mature calculus develops, it becomes visibly white or yellowish in color unless stained or discolored by some extraneous agency. In addition to being unsightly and undesirable from an aesthetic standpoint, the mature calculus deposits are constant sources of irritation of the gingiva and thereby are a contributing factor to gingivitis and other diseases of the supporting structures of the teeth, the irritation decreasing the resistance of tissues to endogenous and exogenous organisms.

“Emulsion” is defined as a two-phase system liquid composition, where the continuous phase is a surfactant and the discontinuous phase is a coating agent. The emulsion contains chlorhexidine.

“Surfactants” are defined as surface active agents suitable for ingestion, which are particularly effective in imparting flexibility to rawhide when impregnated therein. In a preferred embodiment, said surfactants have the property of being water soluble with a propensity to emulsify water-insoluble coating agents (as defined below), and to hold the coating agent in an aqueous suspension as an emulsion when the mixture is dispersed in water or saliva. Said surfactants may also aid in the dissolution of chlorhexidine. Suitable surfactants, illustrative of the types of substances suitable for use in impregnated, flexible, tough, rawhide chews of the present invention containing chlorhexidine are further detailed below, and in Surfactants: A Practical Handbook, by K. Robert Lange, Pub. C. Verlag, Munich, Germany.

“Coating Agents” are defined as water insoluble or very slightly soluble substances which, when presented to the oral cavity preferably in an emulsified state, will coat the teeth, gums and oral cavity tissue with a thin film of the coating agent. This ablative film has several beneficial properties which are functionally described below.

“Conditioners” are defined as water-soluble substances, usually of high molecular weight, which in combination with the emulsions, surfactants and coating agents help condition (1) the rawhide, making it more flexible, tough and fresh cartilage-like with improved chewing properties and (2) the oral cavity, providing improved palatability by creating a mouth-feel more akin to fresh animal cartilage, bone and tissue. Suitable conditioners, illustrative of the types of substances suitable for use in impregnated rawhide of the present invention, are further detailed below.

“MICRODENT®” and “ULTRAMULSION®” are defined as hot melt emulsions of biofilm disrupting coating substances such as polydimethylsiloxane in surfactants such as nonionic poloxamer surfactants and include those emulsions described in U.S. Pat. Nos. 4,950,479; 5,032,387; 5,057,309; 5,538,667; 5,651,959 and 5,711,936. These patents are incorporated herein by reference. The clinical plaque effect obtained when certain of these combinations of surfactants and coating substances are introduced into the mouths of humans are detailed in Food & Drug Administration (FDA) Docket No. 81N-0033, OTC Volumes 210246 to 210262 and 210339 dated Jun. 17, 1991, filed in response to the FDA call-for-data as reported in the Federal Register, Sep. 19, 1990, 55 Fed Reg., 38560, Vol. VI of said filing; the summary is specifically incorporated herein by reference. “Disruption” is defined as the disruption of the macro-integrity of the rawhide by any one of an infinite series of surface abrasion techniques, slicing, fibrillating, punching, tumbling, squeezing, impacting or otherwise separating portions of the fibrous protein macro structures in rawhide so as to increase or accentuate the impregnation of desired substances into the rawhide piece. Even those substances which are only able to penetrate the rawhide to a small depth can thus be incorporated throughout the rawhide piece. The utilization of various types and quantities of impregnating substances can further accentuate the effectiveness of physical disruption.

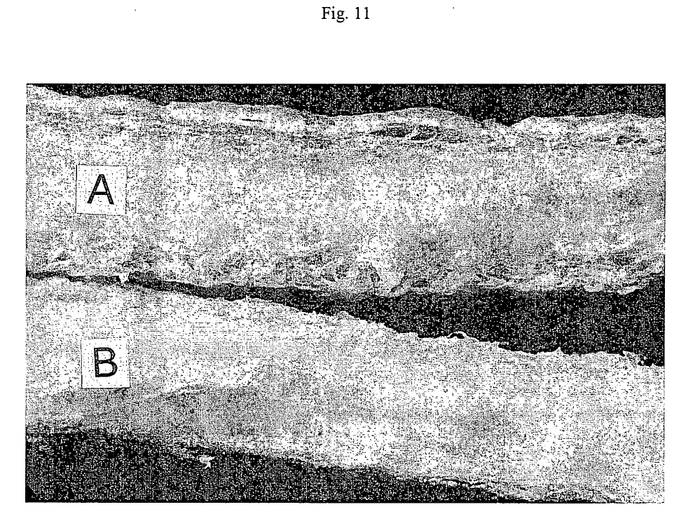

“Impregnating” is defined as a means for treating rawhide to affect distribution of emulsions and/or surfactants containing chlorhexidine substantially throughout the rawhide. Impregnation can be achieved by certain substances by simply soaking the rawhide in solutions/dispersions of emulsions and/or surfactants until they have penetrated throughout the rawhide chew. In a preferred embodiment of the invention, in those instances where substances, such as the emulsions and/or surfactants of the present invention containing antimicrobially active chlorhexidine and certain other ingredients, achieve minimal penetration of the rawhide substrate under various soaking conditions, as shown in FIG. 11, the rawhide substrate is physically disrupted using various physical means to disrupt the rawhide and open passageways throughout the rawhide, as shown in FIG. 1b and also FIG. 11. These passageways augment impregnation throughout the rawhide with those various emulsions and/or surfactants that do not, on their own, penetrate substantially throughout the rawhide during various soaking procedures, as shown in FIG. 1c. In a preferred embodiment of the invention, to achieve “impregnating,” various means of physically disrupting rawhide can be utilized including: bending repeatedly, meshing, probing, scoring, fibrillating the surface of the rawhide, etc. Impregnating includes physical-chemical disruption of the rawhide. That is, the disruption of the micro-integrity of the collagen, collagen-like, water soluble or water dispersible proteins which are present in fresh and dried rawhides, and where in conventional dried rawhide, the proteins bind or “glue” the proteinacious fibers of rawhide together into hard, rigid, brittle matrices; by an agent capable of acting in a physical-chemical manner without changing the molecular structure of the “glue” materials. Substances suitable for such physical-chemical disruption include emulsions of coating substances in suitable surfactants and/or suitable surfactants themselves, which prevent the collagen-like molecules from acting as a “glue.”

Impregnating substances also function as flexibility substances, once they have impregnated the rawhide. That is, a “flexibility substance” is defined as a chemical agent capable of lubricating the fibrous matrix of rawhide without degrading the inherent strength of the individual fibers. Flexibilizing substances enter into the interstitial spaces between the fibers as a solution or as an emulsion, while functioning as an impregnating substance, which after having wet the capillaries of the rawhide in their solution phase for purposes of impregnation of the ingredients, proceed to function as lubricants in their solid or liquid phase upon removal of the water of solution. “Coating agents”, as defined above, provide a convenient reference to the variety of impregnating substances which serve the function of a flexibilizing substance. For purposes of the present invention, the most common classes of flexibilizing substances include emulsifiable polymers like silicones, natural, artificial and petroleum-based waxes, and water-dispersible, low molecular weight polyolefins or copolymers.

“Emulsion and/or Surfactant Impregnated Rawhide” is defined as rawhide impregnated substantially throughout with an emulsion and/or surfactant containing antimicrobially active chlorhexidine that remains antimicrobially active throughout the chew-life of the pet chew. See FIGS. 1c and 11. MICRODENT® and/or ULTRAMULSION® can be “impregnated” into fresh, rawhide that has been disrupted by means of a marinating process, whereby the fresh, disrupted hides soak in a MICRODENT® and/or ULTRAMULSION®/water mixture for extended periods at temperatures ranging from room temperature to elevated temperature. Alternatively, the MICRODENT® and/or ULTRAMULSION® can be added to dried rawhide chews, etc., by soaking the dried chews, which have been previously physically disrupted or which are simultaneously disrupted, at varying temperatures over a wide range of soaking periods using means such as illustrated in FIGS. 2 through 10a. Various emulsion and/or surfactant, impregnated antimicrobially active pet chews of the invention are detailed in the Tables and Examples set out below. The rawhide to be treated with MICRODENT®, or ULTRAMULSION® or surfactants can be fresh; however “preformed pet chews” that have already been physically disrupted and dried can also be impregnated with the emulsions and/or surfactants of the invention. In addition, comminuted rawhide generally produced from trimmings, etc., of formed rawhide chews, i.e., knotted bones, is also suitable, particularly for antimicrobially active pet chews of the invention with no adverse effect to the pet due to choking, blockage, etc.

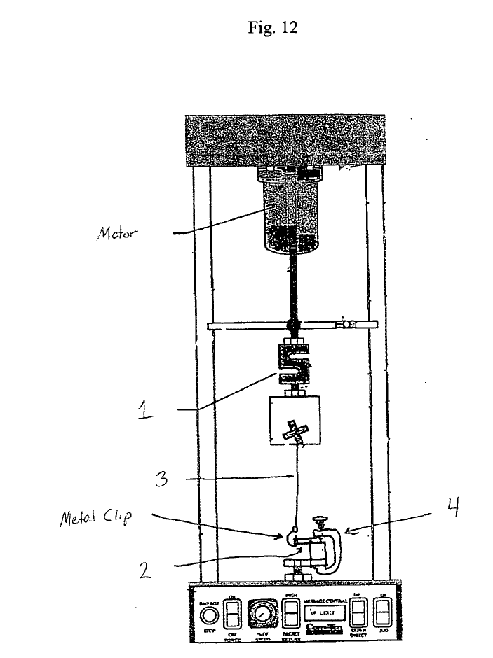

“Flexible Rawhide” is defined as impregnated rawhide that indicates an elasticity (flexibility value) of at least about 0.1 Gigapascal (Gpa) using the Tensile Testing Machine shown in FIG. 12.

“Flexibility Value” is defined in terms of Elasticity Modulus having the formula:

$$E = \frac{{FL}^{3}}{3 DI}$$

Where:
E=Elasticity Modulus in Gigapascals
F=Force in Neutrons
L=Length in meters
D=Deflection in meters
I=Moment of Inertia.

Flexibility of the impregnated rawhide chews of the present invention is established as described in Example 20 and Table 4 below using the Tensile Test Machine described in FIG. 12. The Flexibility measured in Gigapascals (Gpa) ranges from at least about 0.1 to about 0.7 with an average of about 0.382 for strips of impregnated rawhide of the invention. Flexibility values of at least about 0.1 Gpa are preferred.

The flexibility is compared to comparable size commercial rawhide strips which indicate an average Gpa of about 0.731.

“Retained flexibility” is defined as the Modulus of Elasticity of impregnated rawhide chews after storage for prolonged periods under ambient conditions and is measured in Gigapascals (Gpa).

“Shore-D Hardness” of impregnated, flexible, tough, rawhide chews of the invention is defined using Durometer Shore-D Hardness Tester, ASTM-D-2240. The average Shore-D Hardness of the impregnated, flexible, rawhide chews of the invention is about 30% lower than that of commercial rawhide chews. See Examples 22 and 23 and Table 5 below. The improved flexibility of these chews, along with their surprising toughness accounts for the unexpected improvement in chew-life. These Shore-D Hardness values also account for the unexpected improvement in oral care attributes such as the control, disruption and removal of biofilms. A Shore-D Hardness of at least about 35 is preferred.

“Comminuted rawhide” is defined as processed rawhide that is molded, pressed, shaped. etc. Comminuted rawhide includes rawhide pieces that are particularized into small sized particles which are shaped into various chews that, when the particles break off from the chew during chewing, they can be readily swallowed and passed through the dog's digestive system without blockage.

“Chew-life” is defined as the duration that a chew containing antimicrobially active chlorhexidine can be chewed, gnawed, licked. etc., by a pet before it is consumed. Chew time defines the period for transferring active ingredient contained in biofilm disrupting emulsions and/or surfactants, which are distributed throughout “impregnated” rawhide pet chews and released during chewing into the oral cavity to treat biofllms and gum disease, while physically cleaning and coating pet tooth surfaces.

“Physical disruption” includes various physical processes which impact rawhide and increase the capacity of rawhide towards impregnation by emulsions and surfactants as schematically shown in FIGS. 1a through 1c and actually shown in FIG. 11.

“Antimicrobially Active Chlorhexidine” is defined as various chlorhexidine salts including the digluconate (1,1-hexamethylene bis [5-(p-chlorophenyl)biguanide]di-D-gluconate, which indicate antimicrobial activity when impregnated in rawhide pet chews of the invention. Chlorhexidine digluconate is a salt of chlorhexidine and gluconic acid. It is a strong base, practically insoluble in water. Solubility is dependent on the salt form.

Chlorhexidine digluconate is the most soluble form of chlorhexidine. Its chemical structure is:

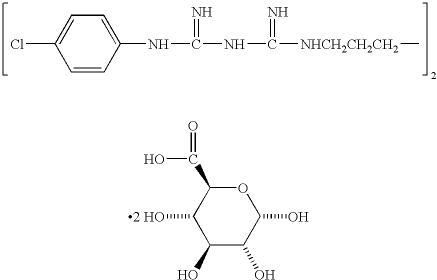

Antimicrobially active chlorhexidine is contained in emulsions and/or surfactants which are distributed throughout the impregnated rawhide pet chews of the invention, and are released into the pet's oral cavity during chewing.

### DETAILED DESCRIPTION OF PREFERRED EMBODIMENTS

The skins of animals contain collagens and other water-soluble or water-dispersible proteins. In the process of converting the inside layer of those skins into rawhide, these proteins are retained in, or may even be extracted from the cellular structure into, the interstitial spaces between the fibrous material. Upon drying, these proteins bind, or “glue” the fibrous material into hard, brittle, sharp-edged matrices. The mechanism of action of an impregnating substance of the invention in introducing itself, and antimicrobially active chlorhexidine, into the interior of the rawhide piece during the production of the flexible rawhide of the invention is three-fold:
(1) The surfactant, either alone or as the dispersing agent for an emulsion, opens up the spaces between the fibers, wets the capillary spaces and thus, as would happen in a capillary tube, promotes penetration by pulling the solution or dispersion along the capillary walls and between the fibers, carrying not only itself, but agents including chlorhexidine which are soluble or dispersible in the impregnation solution, deep into the capillary spaces This can occur without physical disruption or can be augmented by physical process mechanics.
(2) Once in the capillary spaces, the surfactant and/or emulsion solubilize, disperse, and/or commingle with the proteins due to the physical-chemical attraction forces between the collagens, collagen-like, water-dispersible and/or water-soluble proteins and the impregnating substance. After drying, the impregnating substance, being non-volatile, remains in the capillary spaces, being intimately commingled with the proteins and thereby reduces the ability of the proteins to serve as glue-like agents. It is observed that impregnating substances of the invention, including physical-chemical action materials such as surfactants, will prevent a proteinaceous glue from developing adhesion and bonding strength. It is this property that provides a physical-chemical starting point for the unique flexibility of this invention.
(3) Antimicrobially active chlorhexidine is also intimately dispersed in the impregnating substance. This reduces the ability of ingredients which would normally be attracted to the surface of the fibrous proteins to be strongly bound thereto, and upon the introduction of saliva during chewing, the ingestible, antimicrobially active chlorhexidine is more easily dispersed, and for longer periods, into the oral cavity. This property of the impregnating substance to act both as a capillary penetrating agent and a release agent throughout the chew-life of the flexible rawhide chew, further distinguishes the flexible, tough, impregnated, rawhide pet chews of the present invention from the prior art.

To increase the flexibility after impregnation, the physical-chemical impregnating substance “lubricates” the fibrous matrix without degrading the inherent strength of the individual fibers upon which the long-lasting chew-properties of the rawhide depend.

This is accomplished by means of a impregnating substance with lubricating properties. Such substances are typically rather long chain molecules which themselves do not bind to the fibrous matrix, nor to themselves. Rather, they can “slip and slide” across themselves and the solid proteinaceous surfaces of the fibers. Emulsifiable polymers like silicones, natural, artificial and petroleum-based waxes, water-dispersible low molecular weight polyolefins or copolymers will all serve as excellent flexibilizing substances. Their only limitation is that they must function as impregnating substances used to penetrate deeply into the fibrous matrix. In preferred embodiments of this invention, surfactants with long chains, such a poloxamers, sorbitan esters of long chain fatty acids, etc., simultaneously serve as both impregnating and flexibilizing substances.

Referring to FIGS. 1a through 1c, these schematic cross-sectional presentations of: “a piece of intact rawhide” untreated (1a), physically disrupted rawhide (1b), and physically disrupted rawhide that is impregnated with an emulsion and/or surfactant containing antimicrobially active chlorhexidine (1c and 11), clearly illustrate a proposed mechanism of action that accounts for:
(a) the release of antimicrobially active chlorhexidine over the chew-life of the pet chew;
(b) the basis for the flexibility of the impregnated pet chew (with a flexibility value of at least about 0.1 Gpa; and
(c) the toughness of the flexible chew, i.e. having a Shore-D Hardness of at least about 35.

These features are present throughout the chew-life of the chew of the present invention.

Comparing rawhide cross sections shown in 1(a) and 1(b), it is evident that physical disruption of the rawhide, 1, for example by tumbling the rawhide in a rotating barrel tumbler provided with rawhide disrupting fins (shown in FIGS. 2 through 10a) expands various passageways, 2 to 2′, throughout the rawhide by breaking down various collagen structures and protein networks throughout the rawhide. The resultant passageways, 2′, that are formed within the rawhide are then impregnated with the emulsions and/or surfactants containing antimicrobially active chlorhexidine (X) that are present in liquid present in the rotating barrel tumbler during the disruption and impregnating processes.

It appears emulsions and/or surfactants in passageways, 2′, are primarily responsible for the flexibility and toughness properties exhibited by the treated rawhide chews throughout their chew-life.

It has been observed that emulsions and/or surfactants, X, are substantive when impregnated into rawhide passageways, 2′, do not release from passageways, 2′, under stability testing at various temperatures. Thus, emulsions and/or surfactants, X, remain impregnated in passageways, 2′, until this section of the rawhide is chewed and consumed by the pet, during which emulsions and/or surfactants containing antimicrobially active chlorhexidine, X, are released into the pet's oral cavity.

FIGS. 1a through 1c are used to illustrate a proposed mechanism of action that depicts what may physically happen to the rawhide structure when rawhide is subjected to disruption and impregnation. See also FIG. 11. Technical support for FIGS. 1b and 1c is provided in the Examples associated with Tables 2 and 3.

The intact rawhide cross-section, 1a, is schematically represented by circles, 2. After disruption, this cross-section, 1b, is represented by larger circles, 2′. After impregnation, this cross-section, 1c, is represented by some of circles, 2′, containing emulsion and/or surfactant, indicated by X.

Physical disruption of rawhide precedes impregnation by the emulsions and/or surfactants of the invention containing antimicrobially active chlorhexidine. A preferred means for achieving disruption of rawhide centers around tumbling the rawhide in the presence of fixed disruption fins as detailed in FIGS. 2 through 10a.

An example of a rotating rawhide tumbling barrel means with fixed disrupting fins is described below and illustrated in attached FIGS. 2 through 10a of the Drawings.

Physical disruption calls for repetitive bending, impacting with force, etc., of the rawhide such that the infrastructure of the rawhide is expanded to allow impregnation of the disrupted rawhide with emulsions and/or surfactants of the invention, each of which contains antimicrobially active chlorhexidine. Upon drying, the disrupted and impregnated rawhide pet chews of the invention retain the impregnated emulsions and/or surfactants containing the antimicrobially active chlorhexidine throughout the chew-life of the therapeutic pet chew.

Various physical processes for disrupting rawhide can be employed to carry out the required antimicrobially active chlorhexidine containing emulsion and/or surfactant impregnation of rawhide. For example, in addition to the tumbling means described in detail in FIGS. 2 through 10a, alternative disrupting means include: (a) squeezing rawhide through opposing rollers, (b) subjecting rawhide to various impacting means, (c) employing paddle-type stirring means, and (d) subjecting rawhide to intense water pressure means, and the like.

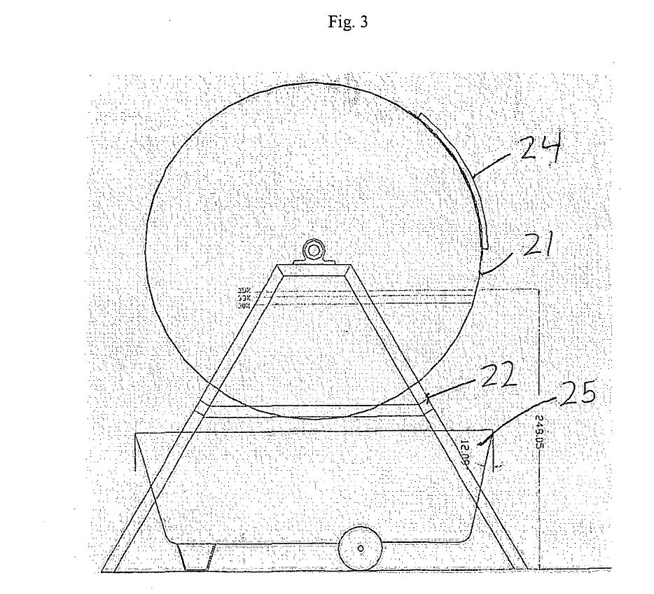

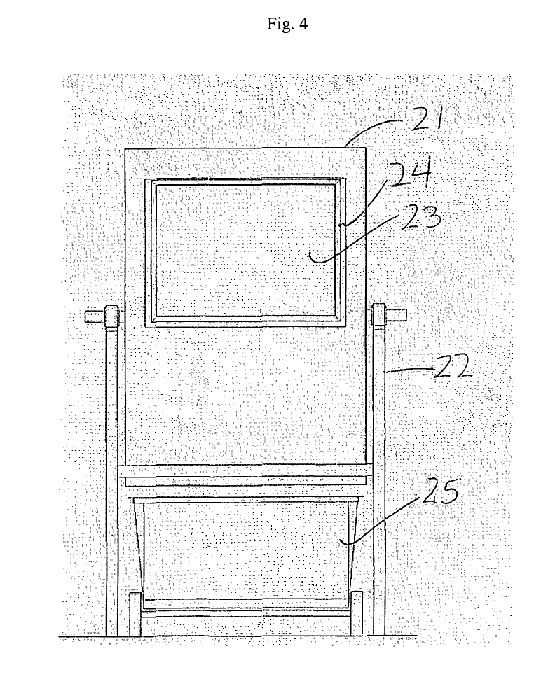

FIGS. 2 through 10a illustrate several tumbling means suitable for physically disrupting and impregnating rawhide. Referring to FIGS. 2, 3 and 4: FIG. 2 is a three-dimensional perspective view, FIG. 3 is a side view, and FIG. 4 is a front perspective view, each illustrating a rotating rawhide tumbling barrel means, 21, rotationally secured to support means, 22. Rotating rawhide tumbling barrel means, 21, is provided with a drive means not shown and an entry means, 23, with closure means, 24. A mixture of rawhide and a liquid containing emulsion and/or surfactant are introduced into barrel means, 21, through entry means 23. After disrupting and impregnating, flexible rawhide is discharged through entry means, 23, into receptacle, transport means, 25.

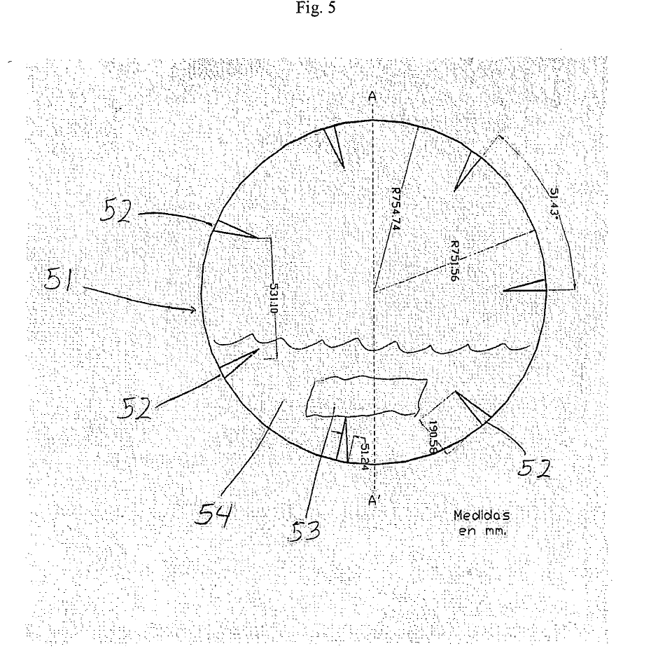

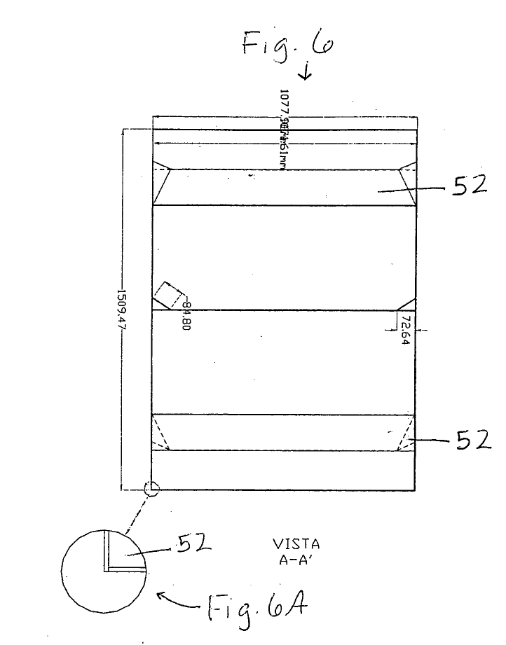

FIGS. 5 through 6a are: inside, cross-sectional and side views respectively, of rotating barrel means, 51. Rawhide disrupting fins, 52 are secured to the inside wall of rotating barrel means, 51, in a pattern that maximizes rawhide disruption during rotation of said barrel means and tumbling of rawhide, 53. Some of these several fins, 52, are engaging rawhide, 53, as barrel means, 51, is rotated, thereby disrupting the rawhide and allowing emulsion and/or surfactant, 54, to impregnate disrupted rawhide, 53.

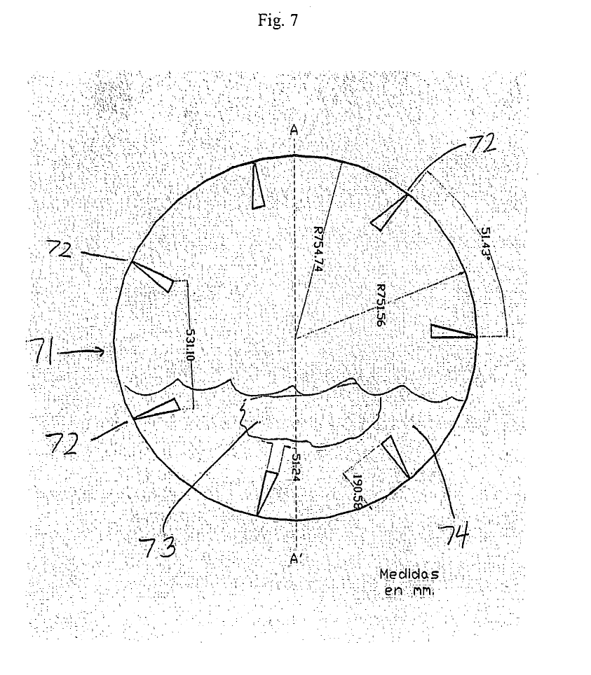

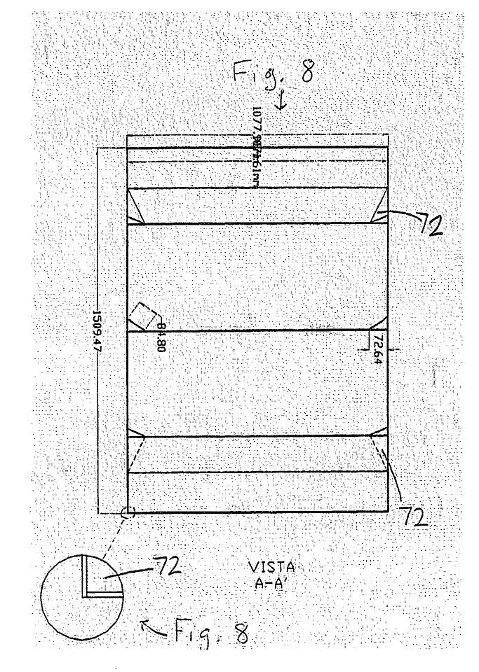

FIGS. 7 through 8a are: inside, cross-sectional and side views respectively, of rotating barrel means, 71. Alternative rawhide disrupting fins, 72, are secured to the inside wall of rotating barrel means, 71, in a pattern that maximizes rawhide disruption during rotation of said barrel means, and tumbling of rawhide, 73. Some of these several fins, 72, are engaging rawhide, 73, as barrel means, 71, is rotated, thereby disrupting the rawhide and allowing emulsion and/or surfactant, 74, to impregnate disrupted rawhide, 73.

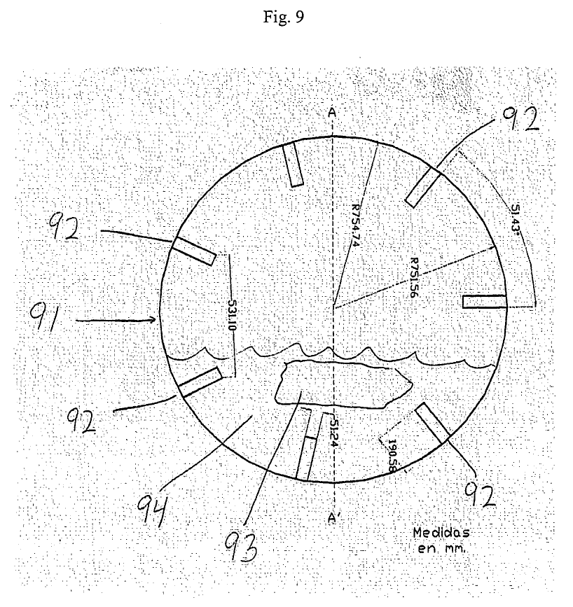

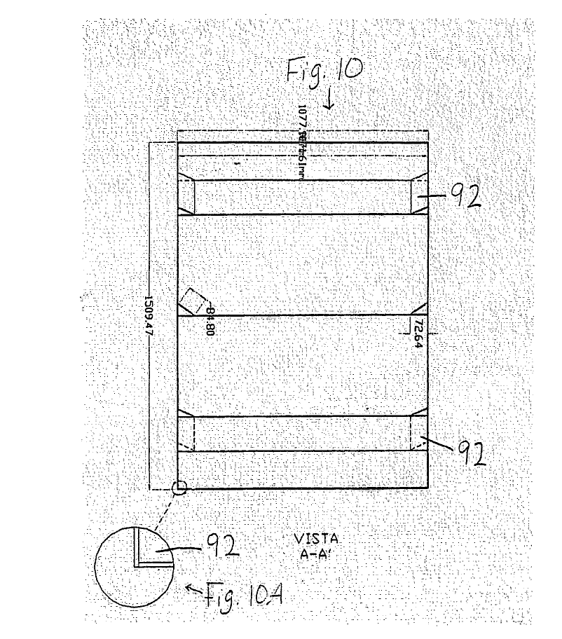

FIGS. 9 through 10a are: inside, cross-sectional and side views respectively, of rotating barrel means, 91. Alternative rawhide disrupting fins, 92 are secured to the inside wall of rotating barrel means, 91, in a pattern that maximizes rawhide disruption during rotation of said barrel means, and tumbling of rawhide, 93. Some of these several fins, 92, are engaging rawhide, 93, as barrel means, 91, is rotated, thereby disrupting the rawhide and allowing emulsion and/or surfactant, 94, to impregnate disrupted rawhide, 93.

Referring to FIG. 11, two rawhide strips were: (a) soaked or (b) disrupted and impregnated, respectively, in a liquid containing 10% by weight MICRODENT® emulsion containing 12,500 cs PDMS as described in Example 1, where the emulsion liquid also contained a blue dye. Cross-sections of the soaked and disrupted/impregnated strips were compared, observed and photographed under a microscope to register the level of blue dyed cross-section surface. These are shown in FIG. 11, which documents the extent of emulsion impregnation throughout the disrupted rawhide of the invention.

FIG. 12 is a side view of a Tensile Testing Machine (ComTen 95T) filled to establish the Elasticity Modulus of impregnated rawhide pet chews of the invention. Load cell, 1, is secured to the rawhide strip to be evaluated, 2, positioned horizontally, by means of string, 3, and clamp means, 4. The force required to move the rawhide strip vertically is recorded and reported in Table 4 below.

The extraordinary saliva flow in carnivores is substantially greater than in humans, and, as a result most therapeutic substances released from coatings on rawhide chews during chewing or introduced into the pet oral cavity via toothpaste, rinses, etc., are readily flushed by the saliva flow from the oral cavity, usually before the therapeutic substance can have any substantial therapeutic effect in the pet's mouth.

The substantivity (residence time in the mouth) of the emulsions and surfactants containing antimicrobially active chlorhexidine of the present invention to tooth and gum surfaces plays a most critical role in effective biofll therapy of pets. The preferred “pet applied” emulsion and surfactant application is via “emulsion and/or surfactant impregnated”, tough, flexible, rawhide chews of the present invention, where the “emulsion and surfactant impregnated” substantially throughout the rawhide chew relies on physical disrupting means to affect “impregnation”.

It has been discovered that when rawhide pet chews are impregnated throughout with (a) emulsions such as MICRODENT® and/or ULTRAMULSIONS®, and/or (b) surfactants containing antimicrobially active chlorhexidine, surprisingly, these emulsions and/or surfactants are consistently available from the chew during chewing, at biofilm disrupting levels. These are released into the oral cavity throughout the chew-life of the pet chew. Most unexpectedly, the antimicrobially active chlorhexidine released remains antimicrobially active over the chew-life. These emulsions and/or surfactants can also contain various other ingredients including conditioners, mouthfeel agents and flavorants which encourage the pet to chew and retain the pet's interest in chewing, over the chew-life of the treated rawhide.

A fundamental shortcoming with rawhide has been that basic rawhide is not particularly palatable and dogs generally lose interest in the product after a relatively short time. Manufacturers have attempted to overcome this shortcoming by coating or basting the rawhide with flavorings, but these overcoatings are usually applied onto the surface and are quickly licked off and/or consumed by the dog, leaving untreated, unpalatable rawhide that is generally unappealing to the pet. In addition, these surface basted coatings tend to soil and/or stain surfaces in the house such as carpeting, rugs, upholstery, etc.

The unexpected availability of emulsions, such as MICRODENT®and ULTRAMULSIONS®, and/or surfactants containing antimicrobially active chlorhexidine released from rawhide pet chews of the invention, over the chew-life of the chew, will not only allow pet owners to now control, disrupt and remove biofilms from their pet's teeth by simply routinely providing their pets with rawhide chews impregnated with MICRODENT® or ULTRAMULSION®-base emulsions and/or surfactants, which emulsions and/or surfactants contain antimicrobially active chlorhexidine, flavorants, conditioners, mouthfeel agents, etc., where the latter render the rawhide chew most palatable; but also treat the pet with various therapeutic ingredients released. These emulsions and/or surfactants can be delivered to the pet's oral cavity with minimal staining and/or soiling of household surfaces in contrast to that experienced heretofore with basted rawhide chews.

Surprisingly, the impregnating of fresh rawhide with emulsions and/or surfactants containing antimicrobially active chlorhexidine minimizes “tying up” of the chlorhexidine with the protein of the rawhide pet chew and allows for the release of these therapeutic ingredients at effective levels throughout the chew-life of the rawhide pet chew. See details on antimicrobially active chlorhexidine as discussed below.

The release of antimicrobially active chlorhexidine from dried, flexible, tough rawhide that is impregnated with antimicrobially active chlorhexidine contained in emulsions and/or surfactants is a primary feature of the invention. See FIGS. 1a through 1c and FIG. 11.

As noted above, the extraordinary saliva flow in carnivores is substantially greater than in humans. As a result, most antimicrobials and other therapeutic ingredients released from rawhide chews during chewing or introduced via toothpaste, rinses, treats, etc., are readily flushed by the pet's saliva flow from the oral cavity before the antimicrobial or other active ingredients can have any substantial antimicrobial effect in the pet's mouth.

This minimum residence time generally negates the therapeutic properties of these various active ingredients. Thus, it is not surprising that the substantivity of the emulsions and/or surfactants to mouth surfaces is a most appealing feature and should play a most critical role in effective treatment of pets. The present invention offers an innovative treatment means for pets based on various antimicrobially active chlorhexidine/emulsion and/or surfactant impregnated rawhide chews [as detailed in the Examples] and discussed below.

It has now been discovered that when rawhide pet chews are impregnated with MICRODENT® or ULTRAMULSION® emulsions and/or surfactants containing antimicrobially active chlorhexidine, which emulsions and/or surfactants are impregnated substantially throughout the disrupted rawhide pet chew, surprisingly, antimicrobially active chlorhexidine is released from the chew into the oral cavity over the chew-life of the pet chew and the impregnated rawhide chew indicates flexibility which is retained throughout its chew-life.

The unexpected availability of antimicrobially active chlorhexidine from emulsion and/or surfactant impregnated rawhide pet chews allows pet owners to now control, disrupt and remove biofilms and/or, to some extent, treat gum disease in their pets by routinely providing their pets with flexible, rawhide chews impregnated substantially throughout with emulsions and/or surfactants containing antimicrobially active chlorhexidine.

Thus, the flexible, tough, rawhide pet chews of the present invention provide a unique combination of continuous and effective therapeutic and physical treatment of biofilms and other pet conditions, neither taught nor implied in the prior art. That is:
(1) The antimicrobially active chlorhexidine/emulsion and/or surfactant impregnated, flexible, tough, rawhide chews of the present invention release therapeutic ingredients into the oral cavity at a fairly constant level over the chew-life of the rawhide; and
(2) This release of antimicrobially active chlorhexidine is accompanied by a physical abrasive/chewing-type action which is supported by improved flexibility of the rawhide chew. This rawhide flexibility is attributed to the emulsion and/or surfactant impregnated substantially throughout the chew. These emulsion and/or surfactant impregnated, flexible chews offer the pet improved shredding, gnawing, ripping, biting, etc., that is normally associated with a dog chewing prey in the wild.

This flexible, impregnated, tough, rawhide chew, which combines physical abrasive/cleaning-type action with the treatment of biofilm effectively controls, disrupts and removes biofilms, while also treating other pet conditions. Key to the efficacy of this combination is the fact that the emulsion and surfactant/antimicrobially active chlorhexidine impregnated, flexible, rawhide chew also contains flavorants, conditioners, mouthfeel agents, etc., that “mask” the “off-taste” of the chlorhexidine that is released into the mouth. That is, these masking flavorants, conditioners, mouthfeel agents, etc., actually do more than mask the chlorhexidine taste; they actually also promote and encourage chewing by the pet. Flavorants, conditioners, mouthfeel agents, etc., with high pet acceptance flavor profiles such as peanut butter, chicken, liver and gravy-type flavors contained in the emulsions and/or surfactants impregnated throughout the rawhide are preferred.

The melt emulsions described as MICRODENT® and ULTRAMULSION® are preferred carriers for “impregnating antimicrobially active chlorhexidine throughout” the therapeutic pet chews of the invention. These are described in detail in the MICRODENT® and ULTRAMULSION® U.S. patents to Hill et. al., referenced above.

Generally, these melt emulsions comprise a coating agent emulsified in surfactants, such as:
sodium lauryl sulfate,
sodium lauryl sarcosinate,
polyethyleneglycol stearate,
polyethyleneglycol monostearate,
coconut monoglyceride sulfonates,
soap powder, sodium alkyl sulfates,
sodium alkyl sulfoacetates,
alkyl polyglycol ether carboxylates such as those described in U.S. Pat. No. 4,130,636 polyoxyethylene derivatives or sorbitan esters, such as those described in U.S. Pat. No. 4,130,636,
polyoxyethylene derivatives or sorbitan esters, such as those described in U.S. Pat. Nos. 3,639,563 and 3,947,570, and
propoxylated cetyl alcohol as described in U.S. Pat. No. 2,677,700.

Preferred commercially available substances which include:
polyoxyethylene-polyoxypropylene block copolymers such as Pluronic F108, and F127 (BASF) and polysorbates such as Tween 40 and 80 (Hercules);
Particularly preferred surfactants include block copolymers comprising a congeneric mixture of conjugated polyoxypropylene and polyoxyethelene compounds having a hydrophobe, a polyoxypropylene polymer of at least 1200 molecular weight; such as described in U.S. Pat. Nos. 4,343,785; 4,465,663; 4,511,563 and 4,476,107.

Suitable coating substances for these melt emulsions can be functionally described as follows. They:
(1) suppress the tendency of the surfactant cleaners present to foam,
(2) are safely ingestible at the concentrations used,
(3) have an affinity for mouth and teeth surfaces,
(4) are neutral, inert and do not support biological activity,
(5) modify the surface energy properties of surfaces of the mouth which they coat such that it is more difficult for food particles, cellular debris and various plaque precursors and formers to attach to these emulsion coated surfaces, and
(6) form a thin, transparent, transient coating that does not build up on mouth surfaces and is removed by the normal cleaning and flushing action of the mouth.

Those coating substances suitable for the melt emulsions of the invention include various silicones, long chain hydrocarbons, carbowaxes and polymers such as:
silicone glycol co-polymers,
polydimethyl siloxanes at viscosities up to 25 million cs, with 2.5 million cs preferred,
long chain hydrocarbons, especially normal paraffins having a chain length of 16 carbon atoms or greater, paraffins with several loci of branching and unsaturation does not create unacceptable toxicity nor lower the solidification point below body temperature, and
Carbowaxes® (polyethylene glycols) and polymers which have limited solubility in ethanol and water solutions where the ethanol or water ratio is greater than 0.3:1 but have essentially no solubility in water or saliva at lower ratios.

Suitable surfactants for impregnating the disrupted rawhide of the present invention include those surfactants described in Surfactants: A Practical Handbook, by K. Robert Lange, Pub. C. Verlag, Munich, Germany; including nonionic, anionic, cationic and amphoteric surfactants.

Those conditioners suitable for impregnation of rawhide to improve its properties of flexibility, toughness and chewing properties are primarily selected from several classes of high molecular weight substances such as:
Purified, soluble proteins such as sodium caseinate, various cereal glutens.
albumins and the like,
Starches and modified starches,
Soluble cellulose derivative such as carboxymethylcellulose,
hydroxymethylcellulose, and hydroxypropylcellulose,
Polyethylene and polyproplyene glycols, and
Water soluble resins such as Gantrez®.
Water insoluble resins such as low molecular weight polyethylenes or various ingestible, synthetic polymers having oxygenated sites which make it possible to dissolve them in small amounts of alcohol and create an emulsion upon dispersing the alcoholic solution into the aqueous impregnating substance solution.

In a preferred embodiment of the invention, the “impregnating” of rawhide chews with emulsions and/or surfactants of the present invention, containing antimicrobially active chlorhexidine, is augmented by physically disrupting the rawhide in the presence of emulsions and/or various surfactants in order to provide for optimum “impregnating” substantially throughout the rawhide.

In addition to the MICRODENT®, ULTRAMULSION® and/or surfactants containing antimicrobially active chlorhexidine, various other ingredients that are soluble or dispersible in said emulsions and/or surfactants can also be “impregnated” throughout the physically disrupted rawhide chews. These other ingredients include:
toothpaste ingredients including anti-tartar ingredients including: sodium hexametaphosphate, tetrasodium pyrophosphate, various other pyrophosphates and sequestering agents, etc.,
whitening ingredients such as calcium peroxide, carbamide peroxide, etc.,
anti-caries ingredients including: sodium fluoride, fluorohexametaphosphate, stannous fluoride, etc.,
flavorants, conditioners, and mouthfeel agents, and
abrasives.

“Impregnating” these various other ingredients substantially throughout the disrupted rawhide chew, as distinguished from coating the surface of the chew with these ingredients, allows the “impregnated” other ingredients to be available consistently to the oral cavity of the pet at effective levels; over the chew-life of the treated rawhide pet chew. This availability of various “impregnated” ingredients consistently over the chew-life of the disrupted pet chew plays a key role in effectively controlling biofilm buildup, the fetid breath associated with biofilms, controlling the formation of tartar and/or calculus and helping to treat gum disease during its formative stages.

In addition to “impregnating” rawhide chews with emulsions and/or surfactants containing antimicrobially active chlorhexidine of the present invention, these emulsions and/or surfactants generally will preferably also contain various flavorants, conditioners, mouthfeel agents, etc., which are also “impregnated” substantially throughout the flexible rawhide. These flavors, conditioners, mouthfeel agents, etc., tend to encourage the pet to chew the rawhide more intensely for longer periods and/or more frequently than the pet would normally do with rawhide that is not emulsion and/or surfactant “impregnated” with flavorants, conditioners, mouthfeel agents, etc. Thus, flavor/conditioner/mouthfeel agent/emulsion and/or surfactant “impregnated”, flexible rawhide is a more effective means for delivering antimicrobially active chlorhexidine into the pet's oral cavity, than rawhide chews that are not flavor/conditioner/mouthfeel agent/emulsion and/or surfactant “impregnated.”

Further, the flavor/conditioner/mouthfeel agent/antimicrobially active chlorhexidine containing emulsion and/or surfactant “impregnated”, flexible, rawhide chews of the present invention are more effective in physically cleaning pet tooth surfaces due to the “drive-to-chew” attributed, in part, to the flavorants, conditioners, mouthfeel agents, etc., distributed substantially throughout the emulsion and/or surfactant “impregnated”, flexible, rawhide chew. This intense “drive-to-chew” prompted by the flavorant and other ingredients impregnated throughout the flexible rawhide chew results in more vigorous: chewing, gnawing, ripping and/or shredding action by the pet over the chew-life of the chew than is normally associated with rawhide that is not so “impregnated” throughout with emulsions and/or surfactants containing flavor/conditioner/mouthfeel agents, etc.

In addition to including flavorants, conditioners, mouthfeel agents and/or antimicrobially active chlorhexidine in the emulsions and/or surfactants to be “impregnated” in rawhide chews, the present invention also covers including additional ingredients such as dispersible abrasives into these emulsions and/or surfactants. The distribution substantially throughout the rawhide chew of an emulsion of MICRODENT® and/or ULTRAMULSION® and/or surfactant containing anti-tartar active ingredients and also containing, dispersed therein, various abrasives of various particle sizes, provides an in-situ-type toothpaste formulation. This impregnated toothpaste is continuously worked over tooth surfaces as the MICRODENT® and/or ULTRAMULSION® and/or surfactant containing antimicrobially active chlorhexidine and abrasives dispersed therein is released from the rawhide chew during chewing by the pet.

Release of various active ingredients such as chlorhexidine and/or other antimicrobials from the “impregnated”, flexible, rawhide chew during chewing can introduce off-flavors that tend to be a “turn-off” to pets. That is, the release of such off-flavors is usually associated with eventual rejection of the chew by the pet and, ultimately, failure of the pet to control biofilms, fetid breath and/or gums disease.

It has been discovered that various flavorants, conditioners, mouthfeel agents, etc., included in the MICRODENT® and ULTRAMULSION® emulsions and/or surfactants containing antimicrobially active chlorhexidine impregnated throughout the rawhide chews neutralize certain “turn-off” flavors and adverse mouth feelings associated with various active ingredients such as other antimicrobials, when these ingredients are “impregnated” throughout rawhide chews of the invention. It has unexpectedly been found that the “impregnated”, flexible, rawhide chews of the present invention containing therapeutic ingredients and certain neutralizing flavorants, conditioners, mouthfeel agents. etc., are generally preferred over untreated rawhide chews and are generally more effective in controlling, disrupting and removing pet biofilms, in controlling fetid breath and treating gum disease.

As discussed above, the most effective flavorants for the “impregnated”, flexible, tough, rawhide chews of the present invention are generally unacceptable to pet owners. That is, the flavors preferred by pets tend to trend towards the odor and flavor of rotten, foul and/or decayed meats generally associated with “road kill” and dead, decaying, putrifying carcasses. These foul odors are a turn-off to pet owners and heretofore have generally been avoided for use with coated pet rawhide chews. Some of these “off-odor” flavorants can be included in the emulsion of the present invention and are preferentially retained inside the rawhide until chewing rather than being easily released into the atmosphere and thus are acceptable to pet owners.

In a preferred embodiment of the invention, the process for “impregnating” rawhide (fresh, dried or comminuted) with the various emulsions, includes physical disruption of the rawhide, preferably by repetitive bending, affected by means of a tumbling process simultaneous with or followed by: soaking and “marinating” the disrupted rawhide under a wide range of conditions. For example:
Soaking and tumbling with various emulsions and/or surfactants at levels from between about 0.1% and about 50% by weight of the soaking medium.
Soaking and tumbling at temperatures from between room temperature and about 80° C.
Soaking and tumbling at durations from between about 30 minutes and about 24 hours.
Soaking and tumbling at pressures ranging from open vessels under no additional pressure to closed pressurized systems at from between about 10 and about 100 psi.
Rinsing to remove various substances used in “impregnating” the rawhide from the surface of the rawhide so that the surface contains a minimum of those substances that have been used to “impregnate” the rawhide.
Drying with and without forced air at temperatures from between about room temperature and about 85° C. for periods ranging from between about 4 hours and 48 hours.

The invention is further described and illustrated by the various examples and illustrative examples described in detail below.

### EXAMPLE 1

Preparation of flexible rawhide containing chlorhexidine:

A rotatable S.S. drum, 60 inches in diameter and 42 inches wide (similar to that shown in FIGS. 1 through 10a), was fitted with a door to allow charging and discharging of rawhide materials. The speed of rotation was set at 8-10 RPM. Fresh, bleached rawhide strips, 455 KG, cut to 2.5 by 7 inches, were charged into the S.S. drum. A separate 55 gallon S.S. drum was fitted with an air driven mixer with two propeller blades 18 inches apart. Water, 165.46 KG, was introduced and agitated to produce a vortex. MICRODENT® flakes, consisting of a solid emulsion of poloxamer 407, 3.87 KG, and polydimethylsiloxane, 12,500 CS, 0.43 KG, were added slowly to the vortex over 10 minutes to produce an aqueous emulsion. An aliquot, 0.516 KG, of chlorhexidine digluconate, 20% aq. solution was added into the vortex over 3 minutes. Beef short rib flavor, 1.72 KG, was added over 2 minutes and stirring continued for 10 minutes.

This solution of 172 KG was added to the rotatable S.S. drum which contained 455 KG of fresh rawhide. Rotation was begun at 8-10 RPM and continued for 1 hour. The strips were removed, placed on drying screens and heated to 60 degrees centigrade for 14 hours with forced air heating. The dried chips were more flexible than standard dried rawhide chips.

The following examples illustrate various embodiments of the invention.

Examples 2 to 10 in Table 1 describe various emulsions and surfactants of the invention suitable for impregnating disrupted rawhide. As indicated in Table 1, these emulsions and surfactants can contain “other” ingredients in addition to the active ingredient.

TABLE 1
Examples 2 through 10

| | | Level of | Rawhide Form | Other ingredients in |
|---|---|---|---|---|
| | Emulsion and/or | Chlorhexidine | F = Fresh | the emulsion and/or |
| Ex. | surfactant composition | Digluconate | D = dried | surfactant |
| No. | (% by wt.) | (% by wt.) | C = comminuted | (% by wt.) |
| 2 | Poloxamer 407 (2.5) | 0.06 | F | Beef flavor (1.0) |
| | PDMS 12,500 CS (0.25) | | | |
| 3 | Poloxamer 407 (5.0) | 0.02 | F | Chicken flavor (0.5) |
| | PDMS 12,500 CS (0.5) | | | |
| 4 | SLS (0.2) | 0.04 | D | Beef flavor (0.5) |
| | Microcrystalline wax | | | |
| | (0.05) | | | |
| 5 | Poloxamer 338 (2.5) | 0.08 | D | Short ribs flavor (1.0) |
| | PDMS 1000 CS (0.5) | | | |
| 6 | Poloxamer 407 (2.0) | 0.05 | C | Beef Flavor (1.0) |
| 7 | Poloxamer 338 (3.0) | 0.06 | D | Chicken flavor (0.5) |
| | Microcrystalline wax | | | |
| | (0.3) | | | |
| 8 | SLS (0.3) | 0.07 | F | Beef flavor (1.0) |
| | PE wax (0.03) | | | |
| 9 | Poloxamer 338 | 0.03 | F | Chicken flavor (0.75) |
| 10 | Poloxamer 407 (2.5) | 0.06 | F | Beef flavor (0.75) |
| | PDMS 2.5 mm CS (0.25) | | | |

Basting vs. soaking vs. impregnation:

Examples 11 to 13, compare basting, soaking and impregnating rawhide:

The level of emulsion impregnated into disrupted (tumbled) rawhide is compared to (a) the level of emulsion contained in rawhide, where the rawhide has been soaked in the emulsion for a comparable period, and (b) the level of emulsion contained on rawhide that has been basted. The results described in Table 2 apply with equal force to chlorhexidine impregnated rawhide.

### EXAMPLE 11

A solution containing 2.5 percent of MICRODENT® (a solid emulsion made from poloxamer 407, 90 percent, and polydimethylsiloxane, 12,500 CS, 10 percent) was prepared by stirring for 30 minutes along with 0.3 percent chlorhexidine digluconate, 20% aq. solution and 1.0 percent short ribs flavor. Rawhide squares were numbered and added to a 55 gallon S.S. tumbling drum fitted with 4 fins equally spaced around the circumference. The drum was sealed and rotated at 12 RPM for 1 hour. Squares were removed, dried at 60 degrees centigrade for 12 hours. Each square was analyzed by FTIR for silicone content and by HPLC for chlorhexidine content.

### EXAMPLE 12

The solution of example 11 was prepared and added to a S.S. bowl. The fresh rawhide squares were added and turned over gently every ten minutes for one hour. Squares were dried and analyzed as in example 11.

### EXAMPLE 13

The solution of example 11 was added to a S.S. bowl and fresh rawhide squares were immersed for 15 seconds and then drained for one minute. Squares were dried and analyzed as in example 11.

The preferred disrupting means used is a rotating barrel tumbling means comparable to that described in FIGS. 2 through 10a.

The results from these various treatment procedures of rawhide with a MICRODENT® emulsion are detailed in Table 2 below and can be summarized as follows:
(1) PDMS (polydimethylsiloxane, the coating phase in a MICRODENT® emulsion) was chosen as the impregnated chemical entity to measure since this molecule is completely hydrophobic and has an emulsion particle size ranging from 1 to 10 microns. Thus, it illustrates the surprising effect of an impregnating ingredient of this invention in that not only can totally water insoluble substances be impregnated, even those whose particle size would normally not enter the microscopic passageways.
(2) Tumbling (disrupting) delivers 32% more PDMS (MICRODENT® emulsion) impregnated into the rawhide, per gram of rawhide, than soaking the rawhide in the same MICRODENT® emulsion.
(3) Tumbling (disruption) delivers 36% more PDMS (MICRODENT® emulsion) impregnated throughout the rawhide, per square inch of rawhide surface, than soaking the rawhide in the same MICRODENT® emulsion.
(4) Tumbling (disrupting) and soaking the rawhide for comparable periods delivers the same total PDMS (MICRODENT® emulsion).
(5) The common industry practice of basting, on the other hand, delivers less than 50% of the PDMS and that only to the surface. The PDMS on the inside of the rawhide by either soaking or tumbling with an impregnating ingredient is, surprisingly, infinitely greater than the measurable amount of PDMS inside the basted rawhide.

For these tumbling versus soaking vs. basting tests the following procedure was followed for Examples 11 through 13.

Treatment Procedure:
(1) Squares (26.4×26.4 cm) of uniform thickness of rawhide are selected from each of 4 hides. These squares are divided into four quadrants, assigning diagonally opposing quadrants to each of the treatment groups to reduce positional bias. Opposing quadrant squares are weighed.
(2) The squares to be tumbled are marked with plastic cable ties [pieces from the same hide are bound together and added to standard 50 kg tumble batch (add 18.9 kg of the emulsion described in Example 1 is added) and tumbled for one hour]. Impregnated rawhide is removed from tumbler and dried as chips.
(3) The squares to be soaked are marked with plastic cable ties (pieces of the same hide are bound together). Note the combined wet weight of the squares to be soaked is determined and the squares are placed in a suitable container. Three times the same ratio of emulsion solution as in the tumble example are added, i.e. 50:57 described in (2) above. Squares are turned gently every 10 minutes to assure complete contact with the emulsion solution for a total soak time of one hour. Samples are removed from container, allowed to drain and dried as chips.
(4) Samples of rawhide squares dried similar in quantity and approximately equal in weight to that used in the soak vs. tumble samples are dried down and untreated (wet weight X 0.3785).
(5) Standard basting process is simulated by immersing samples in (4) for 15 seconds in the same emulsion solution. Remove and drain for one minute each side on screen. Weigh the wet basted weight and calculate the quantity of emulsion solution adhering to the rawhide square. Dry as basted squares.

Analysis Procedure:
(1) Maintain data so that the pieces that are linked by plastic tie can be correlated with each other as being from same hide, or averaged for the entire treatment group as desired.
(2) Rinse the MICRODENT® emulsion solution from each square by dipping into chloroform for 2 minutes. Reduce chloroform volume and assay for PDMS. Record as “Outside PDMS.” The “basted” chips may be analyzed as a group since there is no record of which hide they came from.
(3) Cut the squares or chips into small bits and extract with chloroform. Reduce chloroform volume and assay for PDMS. Record as “Inside PDMS.” The “basted” chips may be analyzed as a group since there is no record of which hide they came from.

Actual Weights of Chips used in Treatment Steps #2 and #3:

| # ties | Hide # | SOAK | TUMBLE |
|---|---|---|---|
| 0 | 1 | 125 | 130 |
| 1 | 2 | 85 | 90 |
| 2 | 3 | 65 | 70 |
| 3 | 4 | 90 | 85 |

As to Basted Rawhide Chips:

Seven chips selected.

Total surface area (both sides) of the seven chips @ 1011 square inches.

Ave. surface area (both sides) of the chips @ 15.1 square inches.

Initial Dry Wt. of Chips=144 grams @ 20 grams/piece.

Wet. Wt. of Chips after 15 sec immersion and drain=156 grams.

Wt. of Emulsion Liquid remaining on surface of chips=12 grams.

TABLE 2
Basting vs. Soaking vs. Impregnation
(Examples 11 through 13)

| | | | | | | PDMS | | |
|---|---|---|---|---|---|---|---|---|
| | | Surf | PDMS | PDMS | PDMS | Outside | Total | |
| | Tumbled | area | Inside | Outside | Inside | (mg/sq | PDMS | Ratio |
| Ex. No. | (grams) | (sq cm) | (mg) | (mg) | (mg/g) | cm) | (mg) | (in/out) |
| 11 | 64.51 | 172.85 | 30.06 | 26.56 | 0.47 | 30.21 | 56.62 | 113.18 |
| | 43.71 | 175.2 | 18.73 | 25.89 | 0.43 | 18.88 | 44.42 | 72.91 |
| | 34.56 | 160.81 | 20.74 | 22.6 | 0.60 | 20.66 | 43.34 | 91.77 |
| | 39.53 | 160.85 | 24.89 | 16.7 | 0.63 | 24.99 | 41.59 | 149.04 |
| | | | | Avg. = | 0.53 | 23.74 | 46.49 | 106.72 |
| 12 | Soaked | | | | | | | |
| | 62.86 | 176.29 | 24.62 | 30.77 | 0.39 | 24.79 | 55.39 | 80.01 |
| | 41.03 | 165.9 | 13.65 | 29.82 | 0.33 | 13.83 | 43.47 | 45.77 |
| | 30.26 | 168.72 | 15.15 | 29.32 | 0.50 | 15.32 | 44.47 | 51.67 |
| | 39.97 | 160.82 | 15.64 | 23.33 | 0.39 | 15.79 | 38.97 | 67.04 |
| | | | | Avg. = | 0.40 | 17.43 | 45.58 | 61.12 |
| 13 | Basted | | | | | | | |
| | 137.05 | 200.8 | 0 | 21.34 | 0 | 0.11 | 21.34 | |

### EXAMPLES 14 THROUGH 19

The extended chew-life availability of chlorhexidine is established in these Examples. Chlorhexidine contained in an emulsion (similar to that described in Example 1) was impregnated throughout rawhide that had been disrupted and impregnated by tumbling the rawhide in a rotating chamber fitted with disrupting fins as depicted in FIGS. 2 through 10a of the Drawings.

The results set out in Table 3 below show that the emulsion impregnated/disrupted rawhide of the invention releases chlorhexidine contained in the emulsion slowly and fairly consistently over a 30-minute period, at pH 9, the average pH of a pet's mouth.

Five gram samples of chlorhexidine contained in an emulsion impregnated throughout rawhide were stirred in 100 mL of three solutions. At various times, aliquots of the liquid were removed and analyzed for chlorhexidine content. The results are shown in Table 3 below.

TABLE 3
Impregnated Chlorhexidine-Containing Rawhide
Compared to Chlorhexidine Coated Rawhide
(Examples 14 through 19)

| | | Minutes | | | | | | |
|---|---|---|---|---|---|---|---|---|
| Ex. No. | 0.1 N Hydrochloric Acid | 1 | 2 | 4 | 6 | 8 | 10 | 30 |
| 14 | Impregnated Rawhide of | 12.7 | 14.2 | 18.6 | 22.4 | 24.7 | 25.9 | 33.6 |
| | the invention | | | | | | | |
| | Chlorhexidine ppm | | | | | | | |
| 15 | Virbac ® Chlorhexidine | 4.8 | 5.3 | 5.8 | 6.2 | 6.3 | 6.6 | 8.1 |
| | treated rawhide | | | | | | | |
| | Chlorhexidine ppm | | | | | | | |
| 16 | Neutral Water Impregnated | 1.2 | 1.5 | 2.0 | 2.2 | 2.5 | 2.7 | 3.9 |
| | Rawhide of | | | | | | | |
| | the invention | | | | | | | |
| | Chlorhexidine ppm | | | | | | | |
| 17 | Virbac ® Chlorhexidine | 0 | 0 | 0.8 | 0.8 | 1 | 0.8 | 0.8 |
| | treated rawhide | | | | | | | |
| | Chlorhexidine ppm | | | | | | | |
| 18 | pH 9 | 1.3 | 1.6 | 2.1 | 2.5 | 2.8 | 3.1 | 4.0 |
| | Impregnated Rawhide of the | | | | | | | |
| | invention Chlorhexidine ppm | | | | | | | |
| 19 | Virbac ® Chlorhexidine | 0.3 | 0.3 | 0.3 | 0.3 | 0.3 | 0 | 0 |
| | treated rawhide | | | | | | | |
| | Chlorhexidine ppm | | | | | | | |

The foregoing establishes that the impregnated, disrupted rawhide of the invention releases the chlorhexidine slowly at pH 9, the same pH as a normal dog's mouth, during the normal exposure time as one would like oral care chew products to dispense the active ingredient.

The Virbac® chlorhexidine rawhide sample dumps all the chlorhexidine into the oral cavity at one time, which allows more of the chlorhexidine to be swallowed, thereby minimizing the efficacy of the chlorhexidine.

Flexibility (Elasticity Modulus)

### EXAMPLE 20

Flexibility (Elasticity Modulus) of impregnated rawhide chews of the present invention is established using the Tensile Test Machine illustrated in FIG. 12 of the Drawings. The standard formula for Elasticity Modulus is used, i.e.

$$E = \frac{{FL}^{3}}{3 DI}$$

Where:
E=Elasticity Modulus in Gigapascals
F=Force in Neutrons
L=Length in meters
D=Deflection in meters
I=Moment of Inertia.

Strips of rawhide were cut to standard dimensions of 0.5 inches wide by 2.5 inches long. The tensile test machine (ComTen 95T) was fitted with a clamp to fix the strip in a horizontal position. The strips were drilled with holes 1/16 inch from the fixed end in order to attach a metal clip with string. The string was attached with the standard clamp and force data recorded. The software (CTAP 2.0) plotted the force versus distance on a graph. The thickness of each strip along with its individual width was measured with a digital caliper and recorded. The graphs of force versus distance were linear in the region of 0.1 to 0.5 inch deflection. Values of force for 0.25 inch deflection were taken from the graph.

The results of testing commercial and impregnated rawhide strips of the present invention are summarized in Table 4 below and apply with equal force to chlorhexidine impregnated, flexible, rawhide chews of the invention:

TABLE 4
Flexibility (Elasticity Modulus) for Rawhide

| | |
|---|---|
| | Impregnated Rawhide |
| Commercial Rawhide | of the Invention |

| | Elasticity | | Elasticity |
|---|---|---|---|
| Sample | Modulus (Gpa) | Sample | Modulus (Gpa) |
| A | 0.629 | I | 0.180 |
| B | 0.771 | J | 0.187 |
| C | 0.777 | K | 0.541 |
| D | 1.347 | L | 0.686 |
| E | 0.787 | M | 0.567 |
| F | 0.441 | N | 0.116 |
| G | 0.362 | | |
| H | 0.727 | | |

| | |
|---|---|
| Avg. = 0.731 | Avg. = 0.380 |
| Std. Deviation = 0.277 | Std. Deviation = 0.224 |

A flexibility of at least about 0.1 Gpa is preferred.

Shore-D Hardness:

### EXAMPLES 21 THROUGH 23

Shore-D Hardness values for the impregnated, flexible, rawhide chews of the invention are established and compared to commercial rawhide using Durometer Shore-D Hardness Tester, ASTM-D-2240. Two batches of flexible, impregnated, rawhide chews of the invention were tested and compared to commercial rawhide chews. The results are reported in Table 5 below. An average reduction in hardness of about 30% was indicated for the flexible, impregnated, rawhide chews of the invention compared to commercial rawhide. These results apply with equal force to chlorhexidine impregnated, flexible, rawhide chews of the invention.

Eighteen pieces of impregnated rawhide and 19 pieces of impregnated rawhide of the invention were each tested for Shore-D Hardness and compared to 22 pieces of commercial rawhide. The average Shore-D Hardness of the two impregnated rawhide batches was about 44.0 compared to the average of the commercial rawhide of about 61.9.

TABLE 5
Shore-D Hardness Values

| | | Example 23 |
|---|---|---|
| Example 21 | Example 22 | (Commercial) |
| 43 | 46 | 63 |
| 46 | 39 | 63 |
| 38 | 40 | 64 |
| 40 | 43 | 62 |
| 48 | 37 | 52 |
| 44 | 35 | 60 |
| 40 | 40 | 58 |
| 37 | 47 | 62 |
| 44 | 43 | 72 |
| 45 | 51 | 68 |
| 42 | 34 | 64 |
| 39 | 47 | 66 |
| 42 | 43 | 58 |
| 56 | 48 | 66 |
| 48 | 43 | 59 |
| 60 | 48 | 63 |
| 51 | 46 | 63 |
| 49 | 36 | 57 |
| | 50 | 63 |
| | | 58 |
| | | 62 |
| | | 59 |
| Ex. 21 Avg. = 45.11 | Ex. 22 Avg. = 42.95 | Ex. 23 Avg. = 61.91 |

| | |
|---|---|
| Avg. of Ex. 21 and 22 = 44.0 | Avg. = 61.91 |

Percent reduction in hardness = 29% compared to commercial rawhide

A Shore-D Hardness of at least about 35 is preferred. Illustrative Example 24 through 30 of the invention set out in Table 6 below illustrate various embodiments of the invention:

TABLE 6
Examples 24 through 30

| | | | Physical | | | |
|---|---|---|---|---|---|---|
| | | | Disrupting | | | |
| | Type of | Impregnating | Means | Chlorhexidine | Expected | Expected |
| Ex. | Rawhide | Substance | (time in hours | Digluconate | Flexibility | Shore-D |
| No. | (shape) | (% by wt.) | for disruption) | (% by wt.) | Value | Hardness |
| 24 | strip | Poloxamer 407 | Tumbling | 0.06 | 0.34 | 44 |
| | | (4.5) | (1.0) | | | |
| | | PDMS 12,500 | | | | |
| | | CS (0.5) | | | | |
| 25 | roll | Poloxamer 407 | Tumbling | 0.04 | 0.42 | 48 |
| | | (2.5) | (1.0) | | | |
| 26 | square | Poloxamer 338 | 1.4 inch | 0.02 | 0.35 | 40 |
| | | (3.0) | hole punches | | | |
| | | PDMS 1000 CS | | | | |
| | | (0.25) | | | | |
| 27 | strip | Poloxamer 407 | Fibrillated | 0.05 | 0.39 | 47 |
| | | (2.8) | (0.5) | | | |
| | | PDMS 2.5 mm | | | | |
| | | CS(0.3) | | | | |
| 28 | roll | Poloxamer 338 | Tumbling | 0.08 | 0.35 | 40 |
| | | (3.0) | (1.0) | | | |
| | | PDMS 2.5 mm | | | | |
| | | CS (0.28) | | | | |
| 29 | strip | Poloxamer 407 | Tumbling | 0.07 | 0.37 | 43 |
| | | (5.0) | (1.0) | | | |
| | | PDMS 1000 CS | | | | |
| | | (0.5) | | | | |
| 30 | strip | Poloxamer 407 | Tumbling | 0.06 | 0.43 | 49 |
| | | (3.5) | (1.0) | | | |
| | | PDMS 12,500 | | | | |
| | | CS (0.30) | | | | |

1. A flexible rawhide pet chew containing a liquid impregnating substance selected from the group consisting of emulsions, surfactants and mixtures thereof, wherein said flexible pet chew:
(a) has a Shore-D Hardness of at least about 35,
(b) releases said impregnating substance during chewing throughout its chew-life, and
(c) retains a flexibility value of at least about 0.1 Gpa throughout its chew-life.

2. A flexible rawhide pet chew according to claim 1, wherein said liquid impregnating substance is an emulsion.

3. A flexible rawhide pet chew according to claim 1, wherein said liquid impregnating substance is a surfactant.

4. A flexible rawhide pet chew according to claim 2, wherein said emulsion is selected from the group consisting of MICRODENT®, ULTRAMULSIONS® and mixtures thereof.

5. A flexible rawhide pet chew according to claim 2, wherein said emulsion comprises a coating substance as the discontinuous phase and a surfactant as the continuous phase, wherein said emulsion is present in said rawhide pet chew at from between about 0.1 and about 30% by weight, said emulsion contains ingestible, antimicrobially active chlorhexidine and other therapeutic ingredients selected from the group consisting of flavorants; conditioners; mouthfeel agents; abrasives; vitamins; minerals; antiplaque, antitartar, antimicrobial, vitamin and mineral supplements; systemic therapeutic substances; pesticides; nutraceuticals and mixtures thereof.

6. Impregnated, flexible, rawhide pet chews according to claim 1, wherein said rawhide is selected from the group consisting of fresh rawhide, dried rawhide, compressible rawhide, comminuted rawhide and mixtures thereof.

7. A flexible, rawhide pet chew according to claim 2, wherein said emulsion is comprised of a surfactant substance as the continuous phase selected from the group consisting of:
sodium lauryl sulfate,
sodium lauryl sarcosinate,
polyethyleneglycol stearate,
polyethyleneglycol monostearate,
coconut monoglyceride sulfonates,
soap powder,
sodium alkyl sulfates,
sodium alkyl sulfoacetates,
alkyl polyglycol ether carboxylates, and polyoxyethylene derivatives or sorbitan esters thereof,
propoxylated cetyl alcohol, and polyoxyethylene derivatives or sorbitan esters thereof,
polyoxyethylene-polyoxypropylene block copolymers,
polysorbates,
block copolymers comprising a congeneric mixture of conjugated polyoxypropylene and polyoxyethelene compounds having a hydrophobe,
polyoxypropylene polymers of at least 1200 molecular weight,
and mixtures thereof.

8. A flexible, rawhide pet chew according to claim 2, wherein said emulsion is comprised of a coating substance as the discontinuous phase selected from the group consisting of:
polydimethylsiloxanes at molecular weights up to 25 million cs, with 2.5 million cs preferred,
long chain hydrocarbons, especially normal paraffins having a chain length of 16 carbon atoms or greater, paraffins with several loci of branching and unsaturation does not create unacceptable toxicity nor lower the solidification point below body temperature,
Carbowaxes® (polyethylene glycols) and natural and synthetic polymers which have limited solubility in ethanol and water solutions where the ethanol to water ratio is greater than 0.3:1 but have essentially no solubility in water or saliva at lower ratios;
and mixtures thereof.

9. A method for treating various conditions in pets comprising periodically providing the pet with a flexible, impregnated, rawhide pet chew containing ingestible, antimicrobially active chlorhexidine, having a flexibility value of at least about 0.1 Gpa and a Shore-D Hardness from between about 35 and about 55.

10. A method for impregnating dried rawhide pet chews with an emulsion containing ingestible, antimicrobially active chlorhexidine comprising physically disrupting the rawhide, while soaking said rawhide in an aqueous bath containing said emulsion comprised of surfactant as the continuous phase, a coating substance as a discontinuous phase and antimicrobially active chlorhexidine, wherein: (a) said soaking is carried out over a wide range of temperatures and over a wide range of soaking durations, (b) said emulsion impregnates substantially throughout said rawhide at from between about 0.1 and 30% by weight, and (c) said ingestible, antimicrobially active chlorhexidine remains antimicrobially active over the chew-life of said pet chew.

11. A method for impregnating and imparting flexibility and toughness to dried rawhide pet chews with a surfactant containing ingestible, antimicrobially active chlorhexidine comprising physically disrupting the rawhide, while soaking said rawhide in an aqueous bath containing said surfactant and said antimicrobially active chlorhexidine, wherein: (a) said soaking is carried out over a wide range of temperatures and over a wide range of soaking durations, (b) said surfactant impregnates substantially throughout said rawhide at from between about 0.1 and 30% by weight, and (c) said ingestible, antimicrobially active chlorhexidine remains antimicrobially active over the chew-life of said pet chew.

12. A method for impregnating and imparting flexibility and toughness to fresh rawhide suitable for use as pet chews with an emulsion containing ingestible, antimicrobially active chlorhexidine comprising physically disrupting said rawhide and marinating said fresh rawhide in a soak containing said emulsion, wherein: (a) said rawhide is impregnated with said emulsion at between about 2 and about 10% by weight, (b) said antimicrobially active chlorhexidine contained substantially throughout said pet chew remains antimicrobially active over the chew-life of said pet chew, (c) said disrupted, impregnated rawhide chew retains flexibility and toughness throughout its chew-life.

13. A method according to claim 12, wherein disrupted, fresh rawhide is marinated in an aqueous soak at temperatures ranging from between about room temperature and up to about 80° C. for between about 1 hour and about 24 hours.

14. A method for impregnating dried rawhide suitable for use as pet chews with emulsions containing ingestible, antimicrobially active chlorhexidine and introducing flexibility into said rawhide, comprising physically disrupting said rawhide in the presence of an emulsion, wherein: (a) said dried rawhide is impregnated with said emulsion containing antimicrobially active chlorhexidine at from between about 2 and about 10% by weight, and (b) the antimicrobially active chlorhexidine impregnated throughout said rawhide remains antimicrobially active over the chew-life of said pet chew.

15. A method according to claim 14, wherein dried rawhide is impregnated using an emulsion containing antimicrobially active chlorhexidine at temperatures ranging from between about room temperature and up to about 80° C. for between about 1 hour and about 24 hours.

16. A method according to claim 11, wherein the impregnated pet chew is redried at a temperature ranging from between about 70° F. and about 140° F.

17. A method according to claim 14, wherein the impregnated pet chews is redried at a temperature ranging from between about 70° F. and about 140° F.

18. Flexible, tough, rawhide pet chews impregnated substantially throughout with a melt emulsion comprising surfactant as the continuous phase and a coating substance as the discontinuous phase containing antimicrobially active chlorhexidine, wherein said antimicrobially active chlorhexidine remains antimicrobially active and is released from the flexible, rawhide pet chew throughout its chew-life.

19. A method for treating various conditions in pets comprising periodically providing the pet with a flexible, tough, rawhide chew impregnated with a liquid selected from the group consisting of emulsions, surfactants and mixtures thereof containing ingestible, antimicrobially active chlorhexidine suitable for treating said condition, wherein the antimicrobially active chlorhexidine remains antimicrobially active and is released over the chew-life of said flexible rawhide pet chew.

20. A method for manufacturing therapeutic, flexible, tough, rawhide pet chews comprising impregnating substantially throughout disrupted rawhide an emulsion of surfactant and coating substance containing available ingestible, antimicrobially active chlorhexidine.

21. A flexible, tough, rawhide pet chew according to claim 18, wherein said chew is simultaneously impregnated with said melt emulsion containing said antimicrobially active chlorhexidine and other ingestible ingredients.

22. A flexible, tough, rawhide pet chew according to claim 21, wherein said chew is impregnated with said melt emulsion containing ingestible, antimicrobially active chlorhexidine and other ingredients selected from the group consisting of flavorants, conditioners, mouthfeel agents, abrasives, tartar control agents and mixtures thereof.

23. Flexible rawhide pet chews according to claim 18, wherein said rawhide is selected from the group of fresh, dried, comminuted rawhide and mixtures thereof.

24. A flexible rawhide pet chew according to claim 21, wherein said other ingestible ingredient is selected from the group consisting of vitamins, minerals, nutrients and proteins.
